(19) United States
(12) Patent Application Publication
(10) Pub. No.: US 2010/0169105 A1
(43) Pub. Date: Jul. 1, 2010

(54) Discrete time expansion systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,351

(22) Filed: Dec. 29, 2008

(51) Int. Cl. G10L 21/04

(52) U.S. Cl. 704/503

(57) ABSTRACT

The present invention relates to discrete time expansion systems and methods for expanding a source signal while at least substantially preserving its frequency distribution and obviating a need to smoothen an expanded signal. Such a system may expand the source signal by a preset expansion ratio which is any integer or any real number represented by a ratio of (m+n)/m or (m+n+0.5)/m where m and n are positive integers. The present invention also relates to various methods of expanding the source signal by separating such a signal to multiple sub-signals each in a different frequency range, expanding each sub-signal using different expansion intervals, and generating the expanded signal by superposition of each expanded sub-signals. The present invention also relates to various algorithms and processes for such systems.

### CROSS-REFERENCES TO RELATED APPLICATIONS

The present application claims an earlier invention date of a Disclosure Document entitled the same, deposited in the U.S. Patent and Trademark Office (the “Office”) on Dec. 26, 2006 under the Disclosure Document Deposit Program (the “DDDP”) of the Office, and bearing a Ser. No. 610,329 which is to be incorporated herein in their entirety by reference.

### FIELD OF THE INVENTION

The present invention generally relates to various discrete time scaling systems and methods for expanding a source signal along a time axis while at least substantially preserving its frequency distribution and also obviating a need to smoothen an expanded signal. More particularly, the present invention relates to a time scaling system for extending the source signal by a preset expansion ratio, where the system typically includes a signal separation unit for dividing the source signal into multiple sub-signals each of which may be characterized by a different range of frequency (or a bandwidth), an expansion unit for expanding each of the sub-signals by the expansion ratio, and an output unit for combining the expanded sub-signals to generate the expanded signal. Using such a system, an user may expand the source signal by one of preset expansion ratios which may be any positive integer or any real number which may be represented by a ratio of a sum of m and n to m or another ratio of a sum of m, n, and 0.5 to m, where both of m and n are positive integers. Such a system of the present invention may be characterized by separation of each of the sub-signals to multiple segments starting and terminating at identical (or at least substantially similar) amplitudes and by generation of appended portions which may be appended to such segments while starting and ending at identical (or at least substantially similar) amplitudes. Therefore, the discrete time expansion system of this invention may provide the expanded signal without any audible distortion, thereby obviating needs to rigorous signal processing after such expansion. The present invention also relates to various methods of expanding the source signal by separating such a signal to multiple sub-signals each characterized by a different range of frequency (or a bandwidth), by expanding each of such sub-signals using different intervals of expansion, and by generating the expanded signal by superposition of each of the expanded sub-signals. The present invention further relates to various algorithms for such discrete time expansion as well as various processes for providing such discrete time expansion systems.

### BACKGROUND OF THE INVENTION

It is desirable to modify the duration of an audio signal while retaining a natural sound or modify the pitches in an audio signal without changing the duration. One application is video synchronization. One often needs to adjust a duration of an audio recording to make it exactly the duration of the video clip without modifying its pitch, where acceptable duration discrepancies are generally less than 20%. On the other hand, pitch scaling is often used to slightly adjust the pitch of a recording before mixing it with other recordings. For professional audio applications, time and/or pitch scaling techniques have to meet high quality standards, and it is also desirable to perform necessary computation in real time.

Time scaling and pitch scaling are in some respects the same problem. In order to increase a pitch of a source signal by 1%, one may need to expand the duration of the source signal by 1% and then resample the expanded signal at a rate 1% higher than the original rate.

Perhaps the most naive approach may be simply expanding or compressing the source signal to the effect that such a signal may be played at a rate different from that at which it is provided. For example, FIG. 1A represents an exemplary source signal which includes multiple pulses of different frequencies and define time-dependent amplitudes in which a source signal 10 is generally a sinusoid superposed with multiple pulses 12 of less amplitudes and higher frequencies, whereas FIG. 1B is an expanded signal obtained by stretching the signal of FIG. 1A along a time axis according to a prior art technique. As shown in FIG. 1B, an expanded signal 14 typically corresponds to a stretched version of the source signal 10 by about 300%, i.e., consisting of a single sinusoid which is superposed with multiple pulses 12 similar to those of FIG. 1A. Not only the sinusoid but also multiple pulses 12 of such an expanded signal 14, however, are stretched along the time axis, thereby decreasing their pitches by approximately a half.

Another simple time scaling method may be a conventional cut-and-splice method. Modifying a duration of a signal without altering its pitch may generally require that some samples be created (for time expansion) or discarded (for time compression). Such a cut-and-splice method may be employed to perform expansion or compression of a signal by modifying its waveform or envelope according to a designated expansion or compression ratio. In this technique, a source signal is divided into and cut to multiple segments, regardless of any correlation therebetween. Then, the segments of the source signal may be spliced together to achieve the time scaling according to the designated expansion ratio. For example, FIG. 1C is an expanded signal obtained by applying the cut-and-splice technique on the source signal of FIG. 1A, while FIG. 1D is another expanded signal obtained by applying a similar cut-and-splice technique on the source signal of FIG. 1A but using different expansion intervals according to another prior art technique. Similar to that of FIG. 1B, expanded signals 14 of FIGS. 1C and 1D are also stretched along the time axis by about 300%. Unfortunately and as manifest in FIGS. 1C and 1D, the conventional cut-and-splice techniques tend to generate conspicuous artifacts, primarily because splice points and/or durations of appended (or duplicated) portions (depicted by thin or hair lines in the figures) are rather fixed parameters and no optimization may be permitted. Therefore, the expanded signals 14 obtained by the cut-and-splice technique typically form discontinuities in a beginning portion and/or an ending portion of each of the portions appended to the source signal 10. To overcome such a problem, various signal processing algorithms are used to smoothen and conceal the discontinuities. For example, conventional cross-fading algorithms are applied to junctions between various segments of the source signal 10 and various portions appended thereto or therebetween.

The cut-and-splice techniques may have merits in some applications, where the source signal is divided into multiple segments by every expansion interval which is preferably set for a listener with normal auditory capability not to perceive signal distortion. However, when the source signal carries pulses generated over a wide range of frequencies, the above problem inherent in the cut-and -splice method has been not easy to overcome. For example, employing a smaller expansion interval results in decreasing the pitch of the expanded signal, while using a longer expansion interval may noticeably deteriorate sound quality such as, e.g., double beat, rhythm disorder, and the like. Various algorithms have been proposed to mitigate such inherent problems of the conventional cut-and-splice techniques such as disorders in the pitch and beat of the expanded signals.

U.S. Pat. No. 4,246,617 entitled “Digital system for changing the rate of recorded speech” and issued to Michael Portnoff proposes to apply short-time Fourier transformation to a speech signal and to obtain multiple sub-signals of different frequency bands. Thereafter, sampling intervals of each of the sub-signals are modified (i.e., expanded or compressed) and resulting sub-signals are combined by a short-time Fourier synthesizer to generate an expanded signal.

U.S. Pat. No. 5,845,247 which is entitled “Reproducing apparatus” and issued to Shuji Miyasaki discloses a time-domain method of band-dividing an audio signal into multiple band signals, determining an uniform overlapping range for the band signals, fading out one frame-divided portion of each band signal while fading in another frame-divided portion of such a band signal, cross-fading such portions of each band signal, and then generating a compressed and/or expanded signal by band-synthesis of such cross-faded band signals.

U.S. Pat. No. 6,049,766 entitled “Time-domain time/pitch scaling of speech or audio signals with transient handling” and issued to Jean Laroche describes another time-domain method for determining periodicity of an audio signal while detecting transients therealong and then generating a compressed and/or expanded signal while favoring skipping or repeating segments with high periodicity and while disfavoring skipping or repeating segments with transients, thereby reducing conspicuous artifacts in the compressed or expanded signal.

U.S. Pat. No. 6,232,540 B1 6which is entitled “Time-scale modification method and apparatus for rhythm source signals” and issued to Kazunobu Kondo also describes a time-domain method capable of determining attack points along an audio signal, detecting intermediate portions between the attack points, and inserting a combined wave between such attack points or replacing two waves by such a combined wave, while securing the attacks and without substantially changing such attacks and their proximal portions.

U.S. Pat. No. 6,484,137 B1 which is entitled “Audio reproducing apparatus” and also issued to Hirotsugu Taniguchi et al. teaches another time-domain expansion and compression method which is generally similar to its predecessors. However, this reference proposes to resort to a sequence table which contains a preset sequence of original segments of a source signal and a preset sequence of one or more portions which are to be appended to or between the segments. Thereafter, back ends of the segments and the front ends of the appended portions are smoothened by conventional cross-fading algorithms.

U.S. Pat. No. 6,487,536 B1 entitled “Time-axis compression/expansion method and apparatus for multichannel signals” and issued to Shinji Koezuka and Kazunobu Kondo focuses on time scaling a multichannel signal. More specifically, each channel signal is sequentially cut into multiple segments, where both of starting and ending splice points are commonly determined between all of the signals using preset search parameters. Resulting segments are accordingly expanded or compressed and then synthesized to a multichannel expanded signal.

U.S. Pat. No. 6,753,741 B1 which is entitled “Dynamic time expansion and compression using nonlinear waveguides” and issued to Alp Findikoglu et al. describes another algorithm for expanding or compressing signals. However, this algorithm is specifically developed for effectively capturing a small-amplitude signal which may be biased by large-amplitude signals. In addition, various nonlinear waveguides may tend to manipulate a time scale of the signals, thereby varying pitches of the signals as well.

U.S. Pat. No. 6,801,898 B1 which is entitled “Time-scale modification method and apparatus for digital signals” and issued to Shinji Koezuka proposes yet another time scaling method identifying the splice points by assessing similarity between adjacent segments of a signal each having a prescribed length and then cross-fading a back end of on segment with a front end of a next segment in order to obtain an expanded signal.

In addition, various prior art references disclose signal expansion and compression algorithms which, however, are typically intended for musical instruments or karaoke machines but not applicable to expand or compress time-dependent signals. Examples of a few of such references are U.S. Pat. No. 6,169,241 B1 entitled “Sound source with free compression and expansion of voice independently of pitch” and issued to Masahiro Shimizu and U.S. Pat. No. 6,207,885 B1 which is entitled “System and method for rendition control” and issued to Kenji Nogami et al. In addition, U.S. Pat. No. 6,323,797 B1 entitled “Waveform reproduction apparatus” and issued to Tadao Kikumoto is only applicable to those signals provided in a midi-file format or vocoder format.

Other references such as U.S. Pat. No. 6,791,482 B1 which is entitled “Method and apparatus for compression, decompression, compression/decompression system, record medium,” U.S. Pat. No. 6,778,965 B1 entitled “Data compression and expansion of an audio signal,” U.S. Pat. No. 6,564,187 B1 which is entitled “Signal compression/expansion along time axis having different sampling rates for different main-frequency bands,” and so on, also teach various time-domain algorithms for expanding and/or compressing various signals. These algorithms are generally similar to those described above and, therefore, similarly limited by the same inherent problems of the earlier cut-and-splice algorithms.

In short, conventional cut-and-splice algorithms suffer from a common setback in selecting the splice points. As described above, numerous prior art references have tried and failed in finding the so-called “best” splice points. For example, some algorithms focus on locating the splice points which ensure a similarity of the signal therearound. However, such algorithms tend to end up with irregular expansion periods, leading to irregular beat or rhythm in the expanded signals. Other algorithms focus on synchronizing pitches between the segments of the source signal and portions appended thereto. However, such pitch synchronization algorithms may frequently introduce errors in pitch marking and detecting, which may also cause discontinuities in the expanded signals. In addition, such algorithms may require complicated and/or time-consuming schemes for detecting the splice points as well as for dividing the source signal into multiple segments. Therefore, these algorithms may not permit real-time expansion or compression of the source signal.

In order to obviate such a formidable task of assessing the “best” splice points, some prior art algorithms resort to exploit harmonic properties of the source signal. For example, the source signal is separated into multiple sub-signals (or harmonics) by Fourier analysis, Fourier transformation or other related algorithms and then each of the sub-signals is expanded or compressed according to a preset expansion or compression ratio. However, the prior art harmonic approaches suffer from the same defect, i.e., they have to divide the source signal into multiple segments and each segment has to be Fourier analyzed into various sub-signals. Therefore, when the expanded or compressed segments are appended to each other, they may tend to form similar discontinuities around the junctions. As an alternative, an entire source signal may instead be Fourier analyzed, divided into multiple sub-signals, expanded or compressed based on a preset ratio, and Fourier synthesized to produce the expanded or compressed signal. Such an alternative may be theoretically sound but not practically feasible, for such algorithms may require a formidable number of sub-signals or harmonics in order to approximate the entire source signal by such sub-signals within an acceptable error range. Otherwise, inherent discrepancies between the source and approximate signal may cause pitch distortion and degradation in sound quality.

Accordingly, there is a need for a signal processing system capable of scaling a source signal by a preset ratio while preserving frequency distribution of the source signal and preventing and/or at least minimizing formation of discontinuities along a scaled signal.

### SUMMARY OF THE INVENTION

The present invention generally relates to various discrete time scaling systems and methods for expanding a source signal along a time axis while at least substantially preserving its frequency distribution and also obviating a need to smoothen an expanded signal. More particularly, the present invention relates to various discrete time expansion systems and their algorithms for extending such a source signal by a preset expansion ratio, where the system typically includes a signal separation unit arranged to divide the source signal into multiple sub-signals each of which may be characterized by a different range of frequency (or a bandwidth), an expansion unit arranged to expand each of such sub-signals by the expansion ratio, and an output unit arranged to combine the expanded sub-signals to generate the expanded signal. Using such a system, an user may expand the source signal by one of preset discrete expansion ratios which may be any positive integer or any real number which may be represented by a ratio of a sum of m and n to m [i.e., (m+n)/m] or another ratio of a sum of m, n, and 0.5 to m [i.e., (m+n+0.5)/m], where both of m and n are positive integers. The discrete time expansion system of the present invention may be characterized in separating each sub-signal into multiple segments starting and terminating at identical (or at least substantially similar) amplitudes and in generating appended portions which may be appended to such segments while starting and ending at identical (or at least substantially similar) amplitudes. Accordingly, such a system of this invention may provide the expanded signal without any audible distortion, thereby obviating needs to rigorously process such an expanded signal after such expansion. The present invention also relates to various methods of expanding the source signal by separating such a signal into multiple sub-signals each of which may be characterized by a different range of frequency (or a bandwidth), by expanding each of such sub-signals using different intervals of expansion, and by generating the expanded signal by superposition of each of the expanded sub-signals. The present invention further relates to various algorithms for such discrete time expansion as well as various processes for providing such discrete time expansion systems.

The discrete time expansion systems, algorithms or methods therefor, and processes therefor of the present invention combine various features of time-domain and frequency-domain analysis and, therefore, offer numerous advantages over the prior art algorithms.

First of all, such discrete time expansion systems (collectively referring to algorithms, methods, and processes thereof hereinafter) separate at least one low- and/or high-frequency sub-signal from the source signal and manipulate each of the sub-signals individually. In addition, such systems divide each sub-signal into a different number of segments such that a sub-signal having pulses in a higher frequency range may be divided into more segments than another sub-signal having pulses in a lower frequency range. In other words, the segments of the sub-signal including the high-frequency pulses are generally shorter than the sub-signal with the low-frequency pulses. When desirable, each of the segments may also be arranged to include therein the same or an at least substantially similar number of individual pulses. Therefore, the segments may be expanded by a preset expansion ratio while at least substantially preserving their frequency distribution regardless of characteristics of expansion algorithms applied thereto. Such systems of this invention may seem similar to the prior art harmonic approach as described herein. However, such systems basically differ from the prior art approach, for various discrete time expansion algorithms of the present invention divide each of the sub-signals into a different number of segments depending upon the frequency range of the pulses included in the sub-signal. Accordingly, such systems may at least substantially maintain the frequency distribution of the source signal in the expanded signal.

Separating multiple sub-signals from the source signal may prove beneficial in that each of the sub-signals may tend to oscillate across a preset baseline such as, e.g., an abscissa or time axis with zero amplitude. Accordingly, the systems of the present invention enable an user to divide the source signal into an optimum number of sub-signals each of which may preferentially consist of the pulses in one of multiple preset frequency ranges, while rendering such pulses to oscillate or fluctuate across the baseline in an at least substantially symmetric mode. Thereafter, the splice points may be selected from any points at which the sub-signal may cross the baseline from below to over or vice versa, and each sub-signal may be divided into a preset number of segments each of which in turn may include another preset number of pulses and/or half-pulses. Because each of the sub-signals is to define the identical value at such crossovers by definition, such segments automatically a preset number of the pulses and/or half-pulses each starting and ending at the same amplitude of the baseline. Therefore, such pulses and/or half-pulses of a segment may be appended to such a segment while automatically matching the amplitudes at the junctions and avoiding formation of any discontinuities at the junctions. By the same reason, the systems of this invention also obviate the need to use popular cross-fading algorithms, for no discontinuities are to be formed while appending to the segment such pulses and/or half-pulses each starting and ending at the same amplitudes as the segment.

In addition, such systems of this invention may allow the user to pick one expansion ratio from a wide range of discrete values. For example and as briefly described hereinabove, such expansion ratios may be decided by a number of full- and/or half-pulses included in a given segment of a given sub-signal and by a number of full- and/or half-pulses to be appended to such a segment so that the source signal may be expanded by a variety of expansion ratios each of which may be represented by one of the ratios such as, e.g., (m+n)/m, (m+n+0.5)/m, (m+n)/(m+0.5), (m+n+0.5)/m+0.5), and the like, where both of m and n are positive integers, where m represents the number of full-pulses included in such a segment, where n denotes the number of full-pulses to be appended to the segment, and where 0.5 denotes that one half-pulse is included in the segment or to be appended to such a segment. By varying such values of m and n, the user may obtain a desirable expansion ratio which may coincide with or which may be close enough to a preset value desired by the user. When a specific expansion ratio may be obtained through more than one set of m and n, the user may have an option to select a smaller or larger value of m, depending upon whether a priority may be given to accurate timing, reliable beat or rhythm, and the like.

Such discrete time expansion systems of this invention may offer the benefit of expanding the source signal in real time, for extent of various signal processing required by such systems may not be as rigorous and complicated as those of various prior art algorithms.

The discrete time expansion systems, algorithms or methods thereof, and processes therefor of the present invention may be used for various purposes. In one example, such a system may be incorporated into an audible signal generating device in order to allow an user to play audible signals at slower speeds without lowering a pitch of the signals as well as without distorting quality of such signals. In another example, such a system may be incorporated into an audio mixing device in order to allow the user to extend a playing time of such signals by any of such discrete expansion ratios of this invention without lowering a pitch of the signals and distorting quality thereof. Such discrete time expansion systems, algorithms or methods thereof, and processes therefor of this invention may be employed to temporally expand various signals which may carry audible information and be provided in various formats such as, e.g., wave files (.wav), ram files, mp3 files, au files, aiff files, and so Various discrete time expansion systems of the present invention may be manufactured as a part of the above signal generating devices and/or mixing devices. Such systems may also be made as microchips, printed circuit boards, and/or other articles of commerce which may be retrofit into the above signal generating devices and/or mixing devices. In addition, various algorithms and/or methods of the present invention may be provided as software programs which may be loaded into and run by various operating systems.

In one aspect of the present invention, various signal processing systems may be provided for expanding a source signal which includes multiple pulses by a preset expansion ratio without at least substantially distorting frequency distribution thereof.

In one exemplary embodiment of this aspect of the present invention, a system may include at least one separation unit, at least one expansion unit, and at least one output unit. The separation unit may be arranged to separate such a source signal into at least two sub-signals a first of which may be arranged to include some of the pulses in a first range of frequencies and a last of which may be arranged to include the rest of such pulses in a second range of frequencies which may be higher (or lower) than the frequencies of the first range. Such a separation unit will be referred to as the “type-1” separation unit hereinafter. The expansion unit may be arranged to form a first number and a last number of appended portions for the first and second sub-signals according to the expansion ratio, respectively, and to append each of the portions onto preset locations along each of the sub-signals, where a length of each of the portions for the first sub-signal may be longer (or shorter) than a length of each of the portions for the last sub-signal, where a total number of such portions of the first sub-signals may be less (or greater) than a total number of the portions of the last sub-signal, and where a product of the length and number of such a first sub-signal may be at least substantially similar to a product of the length and number of the last sub-signal. The an output unit may be arranged to add all of the sub-signals appended with the appended portions, thereby forming the expanded signal while at least substantially preserving the frequency distribution of the source signal in the expanded signal. Such an output unit will be referred to as the “type-1” output unit hereinafter.

In another exemplary embodiment of such an aspect of this invention, a system may include at least one separation unit, at least one expansion unit, and at least one output unit. The separation unit may be arranged to separate the source signal into a first sub-signal including the pulses within a first range of frequency and a first last sub-signal having the first rest of the pulses of the source signal, to assess whether such first rest of the pulses may meet a preset criterion, and to separate the first last sub-signal into a next sub-signal including the pulses within a next range of frequency and a next last sub-signal including the next rest of of the pulses of the first last sub-signal, until the next rest of the pulses may meet the above preset criterion. Such a separation unit will also be referred to as the “type-2” separation unit hereinafter. The expansion unit may be arranged to form a different number of appended portions for each of the sub-signals based upon the expansion ratio and then to append each of the appended portions to preset locations of each of the sub-signals, where a length of each of the portions for the first sub-signal may be arranged to be longer (or shorter) than a length of each of the portions for the last sub-signal, where a total number of the portions provided for the first sub-signals may be less (or greater) than a total number of the portions for the last sub-signal, and where a product of the length and number for the first sub-signal may be at least substantially similar to a product of the length and number for the last sub-signal. The output unit of this embodiment may be the above type-1 output unit.

In another exemplary embodiment of such an aspect of this invention, a system may include at least one separation unit, at least one division unit, at least one expansion unit, and at least one output unit. The separation unit may be arranged to obtain the source signal and then to separate the source signal into first number of sub-signals based upon multiple different ranges of frequency so that each of the sub-signals may be arranged to include some of the pulses having frequencies in one of such ranges. Such a separation will be referred to as the “type-3” separation unit hereinafter. The division unit may be arranged to divide each of the sub-signals into a different number of segments such that one of the sub-signals with higher-frequency pulses may define more of such segments than another of the sub-signals with lower-frequency pulses. Such a division unit will be referred to as the “type-1” division unit hereinafter. Such an expansion unit may be arranged to provide the different number of expanded segments for each of the sub-signals and to provide the first number of expanded sub-signals, where each of the expanded segments may be arranged to include one of the segments as well as at least a portion thereof appended thereto, where such appended portions for each of the segments may be arranged to be decided by the expansion ratio, and where each of the expanded sub-signals may be arranged to include all of the expanded segments thereof. The output unit may be arranged to superpose (or add) such expanded sub-signals into an expanded signal, thereby at least substantially preventing distortion of the frequency distribution of the source signal in the expanded signal. Such an output unit will be referred to as the “type-2” output unit hereinafter.

In another aspect of this invention, a signal processing system may be provided for expanding a source signal including multiple pulses into an expanded signal by a preset expansion ratio while at least substantially preventing (or minimizing) formation of discontinuities along the expanded signal.

In one exemplary embodiment of this aspect of the present invention, a system may include at least one separation unit, at least one expansion unit, and at least one output unit. The separation unit of this embodiment may be the above type-1 separation unit. The expansion unit may be arranged to form a first number and a last number of appended portions for the first and last sub-signals based on the expansion ratio, respectively, and to append each of the appended portions onto preset locations along each of the sub-signals, where the sub-signals may be arranged to have amplitudes which may be at least substantially similar to amplitudes of the appended portions in at least a substantial number of the locations. The output unit may then be arranged to add all of the sub-signals appended with the appended portions, thereby providing the expanded signal while at least substantially preventing (or minimizing) formation of the discontinuities along the expanded signal. This output unit will be referred to as the “type-3” output unit hereinafter.

In another exemplary embodiment of such an aspect of this invention, a system may include at least one separation unit, at least one expansion unit, and at least one output unit. The separation unit of this embodiment may be the above type-2 separation unit. The expansion unit may be arranged to provide a different number of appended portions for each of the sub-signals based on the expansion ratio and to append each of the appended portions onto preset locations of each of such sub-signals, where the sub-signals may be arranged to have amplitudes which may be at least substantially similar to amplitudes of the appended portions in at least a substantial number of such locations. The output unit of this embodiment may be the above type-3 output unit.

In another exemplary embodiment of such an aspect of this invention, a system may include at least one separation unit, at least one division unit, at least one expansion unit, and at least one output unit. Such a separation unit of this embodiment may be the above type-3 separation unit. The division unit may be arranged to divide each of the sub-signals into a different number of segments, where at least a substantial number of the segments may be arranged to start at a starting amplitude and to end at an ending amplitude which may be at least substantially similar to the starting amplitude for each of the sub-signals. Such a division unit will be referred to as the “type-2” division unit hereinafter. The expansion unit may be arranged to form the different number of expanded segments for each of such sub-signals and to provide the first number of expanded sub-signals, where each of such expanded segments may be arranged to include one of the segments as well as at least a portion of such one of the segments appended thereto, where at least a substantial number of such portions for each of the segments may be arranged to start at the starting amplitude and to end at the ending amplitude, and where each of the expanded sub-signals may be arranged to include all of such expanded segments thereof, thereby at least substantially preventing formation of discontinuities in the above amplitudes between the segments and the appended portions therefor. The output unit may be arranged to add or superpose the expanded sub-signals one and to generate the expanded signal therefrom. Such an output unit will be referred to as the “type-4” output unit hereinafter.

In another exemplary embodiment of such an aspect of this invention, a system may include at least one separation unit, at least one division unit, at least one expansion unit, and at least one output unit. Such a separation unit of this embodiment may be the above type-3 separation unit. The division unit may be arranged to detect multiple crossovers of amplitudes of each of the sub-signals across a preset baseline and to provide a different number of segments for each of the sub-signals, where the segments for each of the sub-signals may be arranged to extend along a preset number of the above crossovers, thereby ensuring each of the segments to start and end at the baseline. This division unit will also be referred to as the “type-3” division unit hereinafter. The expansion unit mat be arranged to provide such different number of expanded segments for each of the sub-signals and to provide the first number of expanded sub-signals, where each of such expanded segments may have one of the above segments and at least a portion of such one of the segments appended thereto, where at least a substantial number of the appended portions for each of the segments may be arranged to start at the starting amplitude and to terminate at the ending amplitude, and where each of the expanded sub-signals may be arranged to have all of the expanded segments thereof, thereby at least substantially preventing formation of discontinuities in the above amplitudes between the segments and appended portions. The output unit of this embodiment may be the above type-4 output unit.

In another aspect of this invention, a signal processing system may be provided for expanding a source signal having multiple pulses into an expanded signal by a preset expansion ratio which may be a non-unity positive integer.

In one exemplary embodiment of this aspect of the present invention, a system may include at least one separation unit, at least one expansion unit, and at least one output unit. The separation unit of this embodiment may be the foregoing type-2 separation unit. The expansion unit may be arranged to divide each of the sub-signals to a different number of portions and to append each of the portions thereonto by such an expansion ratio times for each of the sub-signals, where a length of each of the portions for the first sub-signal may be arranged to be longer (or shorter) than a length of each of the portions for the last sub-signal, where a total number of such portions of the first sub-signal may be less (or greater) than a total number of the portions of the last sub-signal, and where a product of the length and number of the first sub-signal may be at least substantially similar to a product of the length and number of the last sub-signal. The output unit of this embodiment may be the above type-1 output unit.

In another exemplary embodiment of such an aspect of this invention, a system may include at least one separation unit, at least one division unit, at least one expansion unit, and at least one output unit. The separation unit of this embodiment may be the above type-3 separation unit, and the division unit of this embodiment may be the above type-1 division unit. The expansion unit may be arranged to provide the different number of expanded segments for each of such sub-signals and to provide the first number of expanded sub-signals, where each of such expanded segments may be arranged to include each of the segments arranged successively by the expansion ratio times and where each of the expanded sub-signals may be arranged to include all of the expanded segments thereof, thereby at least substantially preserving frequency distribution of the source signal. The output unit of such an embodiment may be the above type-4 output unit.

In another exemplary embodiment of such an aspect of this invention, a system may include at least one separation unit, at least one expansion unit, and at least one output unit. The separation unit of this embodiment may be the above type-2 separation unit. The expansion unit may be arranged to divide each of the sub-signals to a different number of segments each of which may start and end at an at least substantially similar amplitude and then to append each of the segments thereonto by such an expansion ratio times. The output unit of this embodiment may be the above type-3 output unit.

In another exemplary embodiment of such an aspect of this invention, a system may include at least one separation unit, at least one division unit, at least one expansion unit, and at least one output unit. The separation unit of this embodiment may be the above type-3 separation unit, and the division unit of this embodiment may be the above type-2 division unit. The expansion unit may be arranged to provide the different number of expanded segments for each of such sub-signals and to provide the first number of expanded sub-signals, where each of such expanded segments may be arranged to include each of the segments arranged successively by the expansion ratio times and where each of the expanded sub-signals may be arranged to include all of the expanded segments, thereby at least substantially preventing formation of discontinuities in the amplitudes in each of the above expanded segments. The output unit of this embodiment may be the above type-4 output unit.

In another aspect of this invention, a signal processing system may be provided for expanding a source signal into an expanded signal by a preset expansion ratio, where the source signal may be a pulse train having multiple pulses therealong and where the expansion ratio may be a ratio of a sum of two positive integers m and n to the m so that the source signal may be arranged to be expanded by a percentage corresponding to a product of the n and 100 divided by the m.

In one exemplary embodiment of this aspect of the present invention, a system may include at least one separation unit, at least one expansion unit, and at least one output unit. The separation unit of this embodiment may be the above type-2 separation unit. The expansion unit may be arranged to provide a different number of appended portions for each of the sub-signals based on the expansion ratio and then to append each of the appended portions in multiple preset locations of each of the sub-signals, where each of such portions may be arranged to include (m+n) of the pulses disposed within a preset distance from each of such locations, where a length of each of the portions of the first sub-signal may be arranged to be longer (or shorter) than a length of each of the portions of the last sub-signal, where a total number of the portions of the first sub-signal may be less (or greater) than a total number of the portions for the last sub-signal, and where a product of the first length and number may be at least substantially similar to a product of the last length and number. The output unit of such an embodiment may be the above type-1 output unit.

In another exemplary embodiment of such an aspect of this invention, a system may include at least one separation unit, at least one division unit, at least one expansion unit, and at least one output unit. The separation unit of this embodiment may be the foregoing type-3 separation unit. The division unit may be arranged to divide each of such sub-signals into a different number of segments, where one of the sub-signals including higher-frequency pulses may be arranged to define more segments than another of such sub-signals including lower-frequency pulses and where each of the segments may be arranged to include at least one pulse. Such a division unit will be referred to as the “type-4” division unit hereinafter. The expansion unit may be arranged to provide the above different number of expanded segments for each of the sub-signals and then to provide the first number of expanded sub-signals, where each of at least a substantial number of the expanded segments may be arranged to have one of the segments including the above (m+n) pulses of such one of the segments appended thereto and where each of the expanded sub-signals may also have all of such expanded segments, thereby at least significantly preserving (or maintaining) frequency distribution of the segments in the expanded segments. The output unit of this embodiment may be the above type-4 output unit.

In another exemplary embodiment of such an aspect of this invention, a system may include at least one separation unit, at least one expansion unit, and at least one output unit. The separation unit of this embodiment may be the above type-2 separation unit. The expansion unit may be arranged to provide a different number of appended portions for each of the sub-signals based on the expansion ratio and then to append each of the appended portions in multiple preset locations of each of the sub-signals, where each of the appended portions may be arranged to include (m+n) of the above pulses disposed within a preset distance from each of the locations and to define amplitudes which may be at least substantially similar to those of each of the sub-signals in at least a substantial number of the locations. The output unit of this embodiment may be the above type-3 output unit.

In another exemplary embodiment of such an aspect of this invention, a system may include at least one separation unit, at least one division unit, at least one expansion unit, and at least one output unit. The separation unit of this embodiment may be the foregoing type-3 separation unit. The division unit may be arranged to divide each of such sub-signals into a different number of segments, where each of the segments may be arranged to include at least one pulse and where at least a substantial number of the segments may be arranged to start at a starting amplitude and to terminate at an ending amplitude which may be at least substantially similar to such a starting amplitude for each of the sub-signals. The expansion unit may be arranged to provide the different number of expanded segments for each of the sub-signals and to provide the first plurality of expanded sub-signals, where each of at least a substantial number of the expanded segments may be arranged to include one of the above segments including such (m+n) pulses of the one of the segments appended thereto, where at least a substantial number of the appended pulses for the segments may be arranged to start and to end at such amplitudes, and where each of the expanded sub-signals may be arranged to include all of its expanded segments, thereby at least substantially preventing or minimizing formation of discontinuities in such amplitudes between the segments and appended pulses. The output unit of this embodiment may be the above type-4 output unit.

In another aspect of this invention, a signal processing system may be provided for expanding a source signal into an expanded signal by a preset expansion ratio, where the source signal may be a pulse train having multiple pulses therealong and where the expansion ratio may be a ratio of a sum of 0.5 and two positive integers m and n to the m such that the source signal may be expanded by a percentage corresponding to a product of 100 and a sum of 0.5 and such n divided by such m.

In one exemplary embodiment of this aspect of the present invention, a system may include at least one separation unit, at least one division unit, at least one expansion unit, and at least one output unit. The separation unit of this embodiment may be the above type-3 separation unit, and the division unit of this embodiment may be the above type-4 division unit. The expansion unit may be arranged to provide the different number of expanded segments for each of such sub-signals and to provide the first number of expanded sub-signals, where each of at least a substantial number of such expanded segments may be arranged to have one of the segments having such (m+n) pulses of such one of the segments appended thereto as well as a half-pulse of the one of the segments, where every other of the expanded segments may also be arranged to be vertically shifted relative to a preset baseline, and where each of such expanded sub-signals may be arranged to include all of its expanded segments, thereby at least significantly maintaining (or preserving) frequency distribution of the segments in the expanded segments. The output unit of this embodiment may be the above type-4 output unit.

In another exemplary embodiment of such an aspect of this invention, a system may include at least one separation unit, at least one division unit, at least one expansion unit, and at least one output unit. The separation unit of this embodiment may be the above type-3 separation unit, and the division unit of this embodiment may be the above type-5 division unit. The expansion unit may be arranged to provide the above different number of expanded segments for each of the sub-signals and to provide the first number of expanded sub-signals. Each of at least a substantial number of such expanded segments may be arranged to include one of the segments including the (m+n) pulses of such one of the segments appended thereto, and one half-pulse of such one of the segments, where every other of the expanded segments may be arranged to be vertically shifted with respect to a preset baseline. At least a substantial number of such appended pulses and half-pulses for the segments may also be arranged to start and end at the amplitudes, and each of the expanded sub-signals may be arranged to include all of the expanded segments thereof, thereby at least substantially preventing formation of discontinuities in the amplitudes between the segments and appended pulses. The output unit of this embodiment may be the above type-4 output unit.

Embodiments of the above systems aspects of the present invention may include one or more of the following features.

The system may receive a source file from an external source, where the source signal may amount to an entire portion or only a portion of the source file. The source file may be in a Wave File format, a Midi Format, an MP3 format, an MPEG format, and any other formats conventionally employed to carry any audible information. The source file may be a mono signal, may include stereo signals in which the source signal may be an entire portion or only a portion of any of the stereo signals. Such a source signal may be an electrical or optical signal and may be an analog or digital signal. Similarly, the expanded signal may also be an electrical or optical signal, may be an analog or digital signal, may be an audible signal, and so on.

The system may include a storage member arranged to store such a source signal and to send such a signal to the control member, to store the expanded signal for later use, to store other values such as the expansion ratio, and so on. The system may include an input member arranged to receive and send the control and/or source signals to the control member, to receive and to send such control and/or source signals to the storage member, and so on. The system may include an output member arranged to play the expanded signal, as each segments of each of the expanded sub-signals of the expanded signal may be generated by the control member, only after all of the expanded sub-signals may be generated thereby, and so on.

The control member of the system may receive the source and/or control signals directly from an user or from the storage member, indirectly through the input member, and the like. Such a control signal may carry information about whether the source signal may be to be expanded or compressed, about the expansion ratio, about a number of the baseline and values thereof, whether at least some of the pulses of the expanded signal may be replaced by at least one of which one of such averages, which mode of expansion may be employed, and the like.

The separation unit may separate from the source signal one sub-signal including some of the pulses in one frequency range from a preset value up to an upper limit of audible frequency, where all the rest of the pulses of the source signal may constitute another sub-signal. The separation unit may separate from the source signal one sub-signal having some of the pulses in another frequency range from a preset value up to a lower limit of audible frequency, where all the rest of the pulses of such a source signal may constitute another sub-signal. The separation unit may separate from the source signal multiple sub-signals including some of the pulses from a lowest (or highest) frequency range to higher (or lower) frequency ranges until the rest of the pulses of the remaining signal may satisfy or meet at least one preset criterion, where examples of such criteria may be whether the rest of such pulses may have their peaks above the baseline and their valleys below the baseline, whether each of upper half-pulses of the rest of such pulses may be at least substantially symmetric with its lower half-pulse, and so on.

The separation unit may also generate any number of the sub-signals based upon any number of such ranges of the frequency, where examples of such number may be 2, 3, 4, 6, 8, 9, 12, 16, 32, 64, and the like. All of the sub-signals may be arranged to have an at least substantially similar length. The ranges of the frequency may be successive and mutually exclusive such that each of the pulses may belong to only one but not more than one of the sub-signals. In the alternative, the ranges of the frequency may be successive and at most minimally overlapping such that each of a majority of such pulses may belong to only one of the sub-signals, while only some of the pulses may belong to two of the sub-signals. At least one of the above sub-signals may be obtained by passing the source signal through one or more conventional filters each arranged to pass some of such pulses within a preset range frequency. At least one the sub-signals may also be obtained by conventional Fourier analysis or transformation, fast Fourier analysis or transformation, discrete Fourier analysis or transformation, and so on.

The division unit may divide the sub-signal in a higher frequency range to more segments than the sub-signal in a lower frequency range. The division unit may generate such segments of the sub-signal in a higher frequency range to have shorter lengths than the segments of such a sub-signal in a lower frequency. The segments may include therein any number of the pulses, e.g., a single pulse, two pulses, three pulses, and so on. The segments of at least one of the sub-signals may include the same or different number of the pulses. Each of the segments may be arranged to include an at least substantially similar number of pulses in all of the sub-signal. At least one segment of one sub-signal may include more (or less) pulses than at least one segment of another sub-signal. At least one of the segments of the sub-signal in the higher frequency range may include a different number of (more or less) pulses from at least one of such segments of the sub-signal in the lower frequency range.

The starting and/or ending amplitudes and/or baselines employed by the division unit in forming the segments may be at least substantially similar for all of the sub-signals or different for at least two of the sub-signals. The starting and/or ending amplitudes may be a zero or another preset amplitude, and the baseline may coincide with a zero-amplitude line, an abscissa or another horizontal line with a preset amplitude. Such segments of at least one of the sub-signals may extend over the same length or different lengths.

The expansion unit may arrange such appended portions and expanded segments of the sub-signal in a higher frequency range to be shorter than the appended portions and expanded segments of the sub-signal in a lower frequency range, respectively. The expansion unit may provide more of the appended portions and expanded segments for the sub-signal in the higher frequency range than the sub-signal in the lower frequency range.

The expansion unit may append the appended portions for the segments of each of such sub-signals before, after, and/or in a middle of each of the segments. The appended portion of one of the segments may be arranged to include at least one of the pulses of such one of the segments, at least one pulse obtained as an average of at least two of the pulses of such one of the segments, at least one pulse obtained from an average of at least one of the pulses of such one of the segments and at least one of the pulses of another of the segments which may be disposed adjacent to such one of the segments, and so on. The appended portion of one of the segments may also include at least one half-pulse of the pulses of such one of the segments, at least one half-pulse obtained as an average of at least two of half-pulses of such one of the segments, at least one half-pulse obtained from an average of at least one of half-pulses of such one of the segments and at least one of half-pulses of another of the segments which may be disposed adjacent to such one of the segments, and the like. At least one of the averages may be obtained as an arithmetic average thereof, a geometric average thereof, an ensemble average thereof, and so on. At least one of the above average pulses may be replaced by a pulse or a half-pulse which may be obtained by conventional filtering or smoothening routines, cross-fading routines, interpolation or extrapolation routines, spline fitting routines, and the like. The expansion unit may be arranged to modify at least one appended portion in order to match an amplitude, a first derivative, and/or a second derivative of the appended portion respectively with the amplitude, first derivative, and/or second derivative of its neighboring pulses. The expansion unit may further be arranged to modify at least one appended portion in order to match an actual duration of the appended portion with a required duration derived by the expansion ratio. The expansion unit may be arranged to select a pulse and/or half-pulse of which the duration may be the closest to the required duration. The expansion unit may be arranged to insert at least one gap in order to match the required duration with or without appending any appended portion.

In another aspect of the present invention, a method may be provided for temporally expanding a source signal with multiple pulses by a preset expansion ratio without at least substantially distorting its frequency distribution.

In one exemplary embodiment of this aspect of the present invention, a method may include the steps of: separating the source signal into at least one first sub-signal including some of the pulses in a first range of frequencies and at least one second sub-signal with others of the pulses in a second range of frequencies which are higher (or lower) than the frequencies of the first range (this step will be referred to as the “type-1” separating hereinafter); providing a first number and a second number of appended portions for the first and second sub-signals based on the expansion ratio, respectively, while arranging a length of the portions for the first sub-signal to be longer (or shorter) than a length of those for the second sub-signal and providing more (or less) of the portions for the first sub-signal than the second sub-signal; appending each of the appended portions to preset locations along each of the sub-signals, while arranging a total length of the portions for the first sub-signal to be at least substantially similar to a total length of those for the second sub-signal; and adding (or superposing) such sub-signals appended by the portions, thereby expanding the source signal into the expanded signal by the expansion ratio while at least substantially preserving the frequency distribution of the source signal in the expanded signal (this step will be referred to as the “type-1” adding hereinafter).

In another exemplary embodiment of this aspect of the present invention, a method may include the steps of: separating the source signal into a first sub-signal including some of the pulses in a first range of frequency and a first last sub-signal including the first rest of the pulses of the source signal (this step will be referred to as the “type-2” separating hereinafter); assessing whether the first rest of the pulses meet a preset criterion; dividing the first last sub-signal into a next sub-signal including some of the pulses in a next range of frequency and a next last sub-signal including the next rest of of the pulses of the first last sub-signal until; repeating such assessing and dividing until the next rest of the pulses meet the criterion; providing a different number of appended portions for each of such sub-signals based on the expansion ratio; identifying multiple locations along each of the sub-signals; appending each of the portions onto each of the locations of each of the sub-signals, while arranging a length of each of the portions for the first sub-signal to be longer (or shorter) than a last length of each of the portions for the last sub-signal, providing a first total number of the portions for the first sub-signals to be less (or greater) than a last total number of the portions for the last sub-signal, and arranging a product of the first length and number to be at least substantially similar to a product of the last length and number; and the above type-1 adding.

In another exemplary embodiment of this aspect of the present invention, a method may include the steps of: separating the source signal into a first number of sub-signals each of which may have multiple pulses having one of the first number of preset ranges of frequency (this step will be referred to as the “type-3” separating hereinafter); dividing each of such sub-signals into a different number of segments in a preset temporal order while providing more of the segments in some of the sub-signals with the pulses in a higher frequency range than others of the sub-signals with the pulses in a lower frequency range (this step will be referred to as the “type-1” dividing hereinafter); appending at least a portion of each of the segments onto such each of the segments according to the expansion ratio, thereby expanding such segments of each of the sub-signals; arranging such expanded segments successively in the preset order for each of the sub-signals, thereby forming an expanded sub-signal for each of the sub-signals; and adding (or superposing) all of such expanded sub-signals, thereby expanding the source signal by the expansion ratio while at least substantially preventing distortion of the frequency distribution of the source signal in the expanded signal (this step will be referred to as the “type-2” adding hereinafter).

In another aspect of the present invention, a method may be provided for temporally expanding a source signal to an expanded signal based upon a preset expansion ratio while at least substantially preventing formation of discontinuities along the expanded signal, where such a source signal may be a pulse train which may include multiple pulses therealong.

In one exemplary embodiment of this aspect of the present invention, a method may include the steps of: the type-1 separating; generating a first number and a second number of appended portions for the first and second sub-signals according to the expansion ratio, respectively; identifying multiple locations along each of the sub-signals; appending each of the appended portions onto the locations along each of the sub-signals, while at least substantially matching amplitudes of the sub-signals with amplitudes of the appended portions in the locations; and adding (or superposing) the expanded sub-signals, thereby generating the expanded signal while at least substantially preventing (or minimizing) formation of the discontinuities in the expanded signal (this step will also be referred to as the “type-3” adding hereinafter).

In another exemplary embodiment of this aspect of the present invention, a method may include the steps of: the above type-2 separating; assessing whether the first rest of the pulses may satisfy a preset criterion; dividing the first last sub-signal into a next sub-signal including some of the pulses in a next range of frequency and a next last sub-signal including the next rest of of the pulses of the first last sub-signal until; repeating such assessing and dividing until the next rest of such pulses may satisfy the criterion; providing a different number of appended portions for each of such sub-signals based upon the expansion ratio; identifying multiple locations along each of the sub-signals; appending each of the portions onto each of the locations of each of the sub-signals, while at least substantially matching amplitudes of the sub-signals with those of such appended portions in at least a substantial number of the locations; and the above type-3 adding.

In another exemplary embodiment of this aspect of the present invention, a method may include the steps of: the foregoing type-3 separating; dividing each of the sub-signals to a different number of segments in a preset temporal order while arranging each of the segments to start and to end at an at least substantially similar amplitude (this step will be referred to as the “type-2” dividing hereinafter); appending at least a portion of each of the segments to the each of the segments according to such an expansion ratio, thereby expanding each of the segments of each of the sub-signals; arranging the expanded segments successively according to the order for each of the sub-signals, thereby forming an expanded sub-signal for each of the sub-signals; and adding (or superposing) the expanded sub-signals, thereby generating the expanded signal (this step will be similarly referred to as the “type-4” adding hereinafter).

In another exemplary embodiment of this aspect of the present invention, a method may include the steps of: the foregoing type-3 separating; detecting multiple crossovers of amplitudes of each of the sub-signals across a preset baseline; dividing each of such sub-signals into a different number of segments in a preset temporal order while arranging each of the above segments to extend between or along a preset number of the crossovers for each of the sub-signals, thereby ensuring each of the segments to start and end at the baseline for each of the sub-signals (this step will be referred to as the “type-3” dividing hereinafter); appending at least a portion of each of such segments to such each of the segments based upon the expansion ratio, thereby expanding each of the segments of each of the sub-signals; arranging the expanded segments successively in the preset order for each of such sub-signals, thereby forming an expanded sub-signal for each of the sub-signals; and then the above type-4 adding.

In another aspect of the present invention, a method may be provided for temporally expanding a source signal including multiple pulses therealong to an expanded signal by a preset expansion ratio.

In one exemplary embodiment of this aspect of the present invention, a method may include the steps of: the above type-2 separating; assessing whether the first rest of such pulses may satisfy a preset criterion; dividing the first last sub-signal into a next sub-signal including some of the pulses in a next range of frequency and a next last sub-signal having the next rest of of the pulses of the first last sub-signal; repeating such assessing and dividing until the next rest of the pulses may satisfy the criterion; dividing each of the sub-signals into a different number of portions, while arranging each of such portions of the first sub-signal to be longer (or shorter) than each of the portions of the last sub-signal and while arranging such a first sub-signal to include less (or more) of the portions than the last sub-signal; appending each of the portions thereonto by the expansion ratio times for each of the sub-signals; and the above type-1 adding.

In another exemplary embodiment of this aspect of the present invention, a method may include the steps of: the above type-3 separating; the above type-1 dividing; appending each of the segments thereonto by the expansion ratio times, thereby expanding each of such segments of each of the sub-signals; arranging each of the expanded segments successively in the preset order for each of such sub-signals, thereby forming an expanded sub-signal for each of the above sub-signals while at least substantially preserving frequency distribution of the source signal; and the above type-4 adding.

In another exemplary embodiment of this aspect of the present invention, a method may include the steps of: the above type-2 separating; assessing whether the first rest of the pulses may satisfy a preset criterion; dividing the first last sub-signal into a next sub-signal including some of the pulses in a next range of frequency and a next last sub-signal including the next rest of of the pulses of the first last sub-signal; repeating such assessing and dividing until the next rest of the pulses may meet the preset criterion; dividing each of the sub-signals into a different number of portions each starting and ending at an at least substantially similar amplitude; appending each of the portions thereonto by the expansion ratio times for each of the sub-signals; and the above type-3 adding.

In another exemplary embodiment of this aspect of the present invention, a method may include the steps of: the above type-3 separating; the above type-2 dividing; appending each of the segments thereonto by the expansion ratio times, thereby expanding the segments of each of such sub-signals; arranging each of the expanded segments successively according to the preset order for each of the sub-signals, thereby constructing an expanded sub-signal for each of such sub-signals while at least substantially preventing formation of discontinuities in the amplitudes in the expanded segments; and the above type-4 adding.

In another aspect of the present invention, a method may br provided for temporally expanding a source signal having multiple pulses into an expanded signal by a preset expansion ratio which may correspond to a ratio of a sum of two positive integers m and n to such m such that the source signal may be expanded by a percentage of a product of the n and 100 divided by the m.

In one exemplary embodiment of this aspect of the present invention, a method may include the steps of: the above type-2 separating; assessing whether the first rest of such pulses may satisfy a preset criterion; dividing the first last sub-signal into a next sub-signal including some of the pulses in a next range of frequency and a next last sub-signal having the next rest of of the pulses of the first last sub-signal; repeating such assessing and dividing until the next rest of the pulses may satisfy the criterion; providing a different number of appended portions for each of the sub-signals based on the expansion ratio while arranging each of the portions of the first sub-signal to be longer (or shorter) than each of the portions of the last sub-signal, while arranging the first sub-signal to include less (or more) of the portions than the last sub-signal, and while arranging each of the portions to include the m pulses and to also include the n pulses both disposed within a preset distance from each of multiple locations of each of the sub-signals; appending each of such portions onto each of multiple locations defined on each of the sub-signals; and the above type-1 adding.

In another exemplary embodiment of this aspect of the present invention, a method may include the steps of: the above type-3 separating; dividing each of such sub-signals to a different number of segments in a preset temporal order while providing more of the segments in some of the sub-signals with the pulses in a higher frequency range than others of the sub-signals with the pulses in a lower frequency range and while providing at least one of the pulses in each of the segments (such a step will be referred to as the “type-4” dividing hereinafter); providing such different number of appended portions for each of the segments based on the expansion ratio while arranging each of the portions to include such (m+n) pulses of such each of the segments which may be appended thereto, thereby at least significantly preserving frequency distribution of the segments therethrough; appending each of the portions to each of the segments, thereby expanding the segments of each of the sub-signals; arranging each of the expanded segments successively in such an order for each of the sub-signals, thereby forming an expanded sub-signal for each of the sub-signals; and the above type-4 adding.

In another exemplary embodiment of this aspect of the present invention, a method may include the steps of: the above type-2 separating; assessing whether the first rest of the pulses may meet a preset criterion; dividing the first last sub-signal into a next sub-signal including some of the pulses in a next range of frequency and a next last sub-signal having the next rest of of the pulses of the first last sub-signal; repeating such assessing and dividing until the next rest of the pulses may satisfy the criterion; providing a different number of appended portions for each of the sub-signals based on the expansion ratio while arranging each of the portions to include such (m+n) pulses disposed within a preset distance from each of multiple locations which may be defined on each of the sub-signals and while arranging the portions to define an at least substantially similar amplitude in at least a substantial number of the locations; appending each of the portions to each of multiple locations defined on each of the sub-signals; and the above type-3 adding.

In another exemplary embodiment of this aspect of the present invention, a method may include the steps of: the above type-3 separating; dividing each of such sub-signals into a different number of segments in a preset temporal order while arranging at least a substantial number of the segments to start and terminate at an at least substantially similar amplitude and while providing at least one pulse in each of the segments (this step will be referred to as the “type-5” dividing hereinafter); providing the different number of appended portions for each of the segments based upon the expansion ratio while arranging each of the portions to have such (m+n) of the pulses of such each of the segments which may be appended thereto, thereby at least significantly preserving frequency distribution of the segments therethrough; appending each of the portions to each of the segments, thereby expanding the segments of each of the sub-signals; arranging each of the expanded segments successively in the preset order for each of the sub-signals, thereby at least substantially preventing discontinuities in the amplitudes between the segments and appended pulses; and the above type-4 adding.

In another aspect of the present invention, a method may be provided for temporally expanding a source signal which may be a pulse train including multiple pulses to an expanded signal by a preset expansion ratio which may correspond to a ratio of a sum of 0.5 and two positive integers m and n to such m, thereby expanding the source signal by a percentage which is a product of 100 and a sum of such n and 0.5 divided by such m.

In one exemplary embodiment of this aspect of the present invention, a method may include the steps of: the above type-3 separating; the above type-4 dividing; providing such a different number of appended portions for each of the segments based upon the expansion ratio while arranging each of the portions to include such (m+n) pulses of such each of the segments appended thereto as well as one of half-pulses of such each of the segments, thereby at least significantly preserving frequency distribution of the segments; appending each of the portions to each of such segments while vertically shifting every other of such segments, thereby expanding the segments of each of the sub-signals; arranging each of the expanded segments successively according to the preset order for each of the sub-signals, thereby constructing an expanded sub-signal for each of the sub-signals; and the above type-4 adding.

In another exemplary embodiment of this aspect of the present invention, a method may include the steps of: the above type-3 separating; the above type-5 dividing; providing the different number of appended portions for each of the segments based upon the expansion ratio while arranging each of the portions to include such (m+n) pulses of such each of the segments appended thereto as well as one of half-pulses of such each of the segments; appending each of such appended portions to each of the segments, thereby expanding the segments of each of the sub-signals; arranging each of the expanded segments successively according to the order for each of the sub-signals, thereby at least substantially preventing discontinuities in the amplitudes between the segments and appended pulses; and the above type-4 adding.

Embodiments of the above methods aspects of the present invention may include one or more of the features which have been described in conjunction with the above systems claims.

In another aspect of this invention, a signal processing system may be provided for expanding a source signal with multiple pulses by a preset expansion ratio without at least substantially distorting frequency distribution thereof.

In one exemplary embodiment of such an aspect of this invention, a system may be made by a process including the steps of: providing a separation unit capable of separating the source signal to at least two sub-signals a first of which may be arranged to have some of the pulses in a first range of frequencies and a last of which may be arranged to have the rest of the pulses in a second range of frequencies which may be higher (or lower) than the frequencies of the first range; providing an expansion unit capable of forming a first number and a last number of appended portions for the first and second sub-signals based upon the expansion ratio, respectively, where such an expansion unit may be capable of arranging each of the portions for the first sub-signal to be longer (or shorter) than each of the portions for the last sub-signal and capable of providing less (or more) of the portions in the first sub-signals than in the last sub-signal; arranging such an expansion unit to append each of the portions to preset locations along each of the sub-signals, thereby forming the expanded signal while at least substantially preserving the frequency distribution of the source signal in the expanded signal; and providing an output unit capable of superposing the sub-signals which may be appended with the portions.

In another exemplary embodiment of such an aspect of this invention, a system may be made by a process including the steps of: providing a separation unit capable of separating such a source signal into a first sub-signal having the pulses in a first range of frequency and a first last sub-signal with the first rest of the pulses of the source signal; arranging the separation unit to assess whether the first rest of the pulses may meet a preset criterion and, if not, to separate the first last sub-signal into a next sub-signal with the pulses in a next range of frequency and a next last sub-signal with the next rest of of the pulses of the first last sub-signal until the next rest of the pulses may satisfy such a preset criterion; providing an expansion unit capable of providing a different number of appended portions for each of the sub-signals according to the expansion ratio while arranging each of such portions for the first sub-signal to be longer (or shorter) than each of such portions for the last sub-signal and arranging the first sub-signal to have less (or more) of the portions than the last sub-signal; arranging the expansion unit to append each of the appended portions to preset locations along each of the sub-signals, thereby constructing the expanded signal while at least substantially preserving the frequency distribution of the source signal along the expanded signal; and providing an output unit capable of superposing the sub-signals appended with the portions.

In another exemplary embodiment of such an aspect of this invention, a system may be made by a process including the steps of: providing a separation unit capable of obtaining the source signal and separating the source signal into a first number of sub-signals based on multiple different ranges of frequency such that each of the sub-signals may be arranged to include some of the pulses having frequencies in one of the ranges; providing a division unit capable of dividing each of the sub-signals into a different number of segments while forming more of such pulses in one of the sub-signals with higher-frequency pulses than another of the sub-signals with lower-frequency pulses; providing an expansion unit capable of generating, for each of the sub-signals, the different number of expanded segments each of which may include one of the segments and at least a portion thereof which may be appended to such one of the segments and determined by the expansion ratio; arranging such an expansion unit to provide the first number of expanded sub-signals each of which may be arranged to include all of the expanded segments thereof, thereby at least substantially preventing distortion of the frequency distribution of the source signal in the expanded signal; and providing an output unit which may be capable of superposing the sub-signals appended with the portions.

In another aspect of this invention, a signal processing system may be provided for expanding a source signal with multiple pulses in an expanded signal based on a preset expansion ratio without at least substantially preventing (or minimizing) formation of discontinuities along the expanded signal.

In one exemplary embodiment of such an aspect of this invention, a system may be made by a process including the steps of: providing a separation unit capable of separating the source signal into at least two sub-signals a first of which may be arranged to have some of the pulses in a first range of frequencies and a last of which may be arranged to have the rest of the pulses in a second range of frequencies which may be higher (or lower) than the frequencies of the first range; providing an expansion unit capable of forming a first number and a last number of appended portions for the first and second sub-signals according to the expansion ratio, respectively, while arranging each of such portions to start and end at an at least substantially similar amplitude; arranging the expansion unit to append each of the portions onto preset locations on each of the sub-signals while arranging the sub-signals to have amplitudes which may be arranged to be at least substantially similar to the amplitude of the appended portions in at least a substantial number of the locations; and providing an output unit which may be arranged to add all of the sub-signals appended with such portions, thereby providing the expanded signal while at least substantially preventing (or minimizing) formation of discontinuities along the expanded signal.

In another exemplary embodiment of such an aspect of this invention, a system may be made by a process including the steps of: providing a separation unit capable of separating such a source signal into a first sub-signal having the pulses in a first range of frequency and a first last sub-signal with the first rest of the pulses of the source signal; arranging the separation unit to assess whether the first rest of the pulses may meet a preset criterion and, if not, to separate the first last sub-signal into a next sub-signal with the pulses in a next range of frequency and a next last sub-signal with the next rest of of the pulses of the first last sub-signal until the next rest of the pulses may satisfy such a preset criterion; providing an expansion unit capable of providing a different number of appended portions for each of the sub-signals according to the expansion ratio while arranging each of such portions for both of such sub-signals to define at least substantially similar amplitudes; arranging the expansion unit to append each of the appended portions onto preset locations along each of the sub-signals while arranging the appended portions to have at least substantially similar amplitudes with the sub-signals in at least a substantial number of the locations; and providing an output unit which may be arranged to add all of the sub-signals appended with the portions, thereby providing the expanded signal while at least substantially preventing (or minimizing) formation of the discontinuities along the expanded signal.

In another exemplary embodiment of such an aspect of this invention, a system may be made by a process including the steps of: providing a separation unit capable of obtaining the source signal and separating the source signal into a first number of sub-signals based on multiple different ranges of frequency such that each of the sub-signals may be arranged to include some of the pulses having frequencies in one of the ranges; providing a division unit capable of dividing each of the sub-signals into a different number of segments while arranging at least a substantial number of the segments to start and to end at an at least substantially similar amplitude for each of the sub-signals; providing an expansion unit capable of generating for each of the sub-signals such different number of expanded segments each of which may have one of the segments and at least a portion thereof which may be arranged to be appended to such one of the segments, to be determined by the expansion ratio, and to start and end at least substantially at the amplitude; arranging the expansion unit to provide the first number of expanded sub-signals each of which may be arranged to include the expanded segments and to start and end at the above amplitude, thereby at least substantially preventing distortion of the frequency distribution of the source signal in the expanded signal; and providing an output unit which may be arranged to superpose the expanded sub-signals one over the other, thereby generating the expanded signal therefrom.

In another exemplary embodiment of such an aspect of this invention, a system may be made by a process including the steps of: providing a separation unit capable of obtaining the source signal and separating the source signal to a first number of sub-signals based upon multiple different ranges of frequency such that each of the sub-signals may be arranged to include some of the pulses having frequencies in one of the ranges; providing a division unit capable of detecting multiple crossovers of amplitudes of each of the sub-signals across a preset baseline and dividing each of the sub-signals to a different number of segments while arranging each of the segments to extend along (or between) a preset number of the crossovers, thereby ensuring each of the segments to start and terminate at the baseline; providing an expansion unit capable of generating for each of the sub-signals such different number of expanded segments each of which may include one of the segments and at least a portion thereof which may be arranged to be appended to such one of the segments, to be determined by the expansion ratio, and to start and end at least substantially at the amplitude; arranging the expansion unit to provide the first number of expanded sub-signals each of which may be arranged to include all of the expanded segments and to start and to terminate at the amplitude, thereby at least substantially preventing distortion of the frequency distribution of the source signal along the expanded signal; and providing an output unit which is arranged to superpose the expanded sub-signals one over the other and to generate the expanded signal therefrom.

More product-by-process claims may be constructed by modifying the foregoing preambles of the systems claims and by appending thereto the above bodies of the method claims. In addition, such process claims may include one or more of the foregoing features of the systems and methods claims of the present invention as described herein.

As used herein, a term “signal” refers to any signal which carries various information on forms of sound which may be obtained as an analog signal of air pressure alteration, through a digitization of such an analog signal, as a digital signal of air pressure alteration, an artificial sound-like signal, and so on. The “signal” may be provided in various conventional formats such as, e.g., wave files (.wav), ram file, mp3 file, au file, aiff file, and other conventional formats. For example, the wave file (.wav) consists of a sequence of bytes representing amplitudes of sound signal in consequent time intervals close enough to represent its form with acceptable precision. Such a “signal” may refer to any signal which carries various information on contents of sound such as, e.g., a pitch, a duration, a volume of different notes, an instrument to be played with, tempo, a modes such as vibrato, echo, reverberation, sustain, etc. This “signal” is typically provided in a format of a midi file which consists of a sequence of various midi events such as, e.g., note-on, channel, a note, velocity, control change, controller, and note-off. Such a “signal” may be provided in an mpeg format or a vocoder format as well.

A “source signal” means a mono or stereo signal which may correspond to an entire portion or only a portion of a source file which may in turn include the signal defined in the preceding paragraph. Such a “source signal” may be an electrical or optical signal and may be an analog or digital signal. An “expanded signal” means the “source signal” temporarily expanded by a preset expansion ratio. Such an “expanded signal” may also be an electrical or optical signal, may be an analog or digital signal, may be an audible signal, and so on.

As used herein, a “sub-signal” refers to a component signal of the source signal and includes only some pulses of the source signal. More specifically, the “sub-signal” may consist of only those pulses of which the frequencies may fall in a preset range. In general, the source signal is generally decomposed into two or more “sub-signals” and, when desirable, 4, 8, 16, 32, 48, 64, 96, 128, and so on, until each of its “sub-signals” may satisfy a preset criterion. The ranges of frequencies of multiple “sub-signals” may be defined exclusive such that all of the pulses having a specific frequency range belong to only one of the “sub-signals.” Alternatively, such frequency ranges may overlap each other such that some pulses having a borderline frequency may belong to two or more “sub-signals.” The “sub-signals” encompassing different frequency ranges are generally arranged to define an identical length or at least substantially similar lengths.

A “segment” means a portion of the “sub-signal” and constitutes a preset number of pulses at least one of which is to be repeated in front of, in the middle of, and/or after such a “segment” in order to expand the source signal by a preset expansion ratio. The “segment” may consist of one or more pulses and/or one or more half-pulses. Different “segments” of a certain sub-signal typically includes the same number of pulses, although exceptions may be allowed. Each of such sub-signals may be divided into the same number of “segments” or, alternatively, into at least substantially similar numbers of “segments.” As will be described below, such “segments” are preferably arranged to start and to end at the same amplitude or at least substantially similar amplitudes.

A term “pulse” represents a portion of the signal and generally extends from one local peak to another local peak, from one local valley to another local valley, and the like. As will be described in detail below, the “pulse” is preferably defined to extend from one crossover across a preset baseline to the second next of such a crossover. As used herein, an “ideal pulse” refers to a pulse including a pair of “half-pulses,” i.e., an upper “half-pulse” and a lower “half-pulse” which are symmetric to each other with respect to the preset baseline.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIG. 1A is an exemplary source signal which includes multiple pulses of different frequencies and define time-dependent amplitudes;

FIG. 1B is an expanded signal obtained by stretching the source signal of FIG. 1A along a time axis according to a prior art technique;

FIG. 1C is an expanded signal obtained by applying a cut-and-splice technique on the source signal of FIG. 1A according to another prior art technique;

FIG. 1D is another expanded signal obtained by applying a similar cut-and-splice technique on the source signal of FIG. 1A according to another prior art technique;

FIG. 2A is the exemplary source signal of FIG. 1A;

FIG. 2B is an exemplary low-frequency sub-signal separated from the signal shown in FIG. 2A according to the present invention;

FIG. 2C is an exemplary high-frequency sub-signal remaining in the signal of FIG. 2A according to the present invention;

FIG. 2D is an exemplary low-frequency expanded sub-signal of the low-frequency sub-signal of FIG. 2B according to the present invention;

FIG. 2E is an exemplary high-frequency expanded sub-signal of the high-frequency sub-signal of FIG. 2C according to the present invention;

FIG. 2F is an exemplary expanded signal of the exemplary source signal of FIG. 2A according to the present invention;

FIG. 3A is the exemplary source signal of FIG. 1A;

FIG. 3B is an exemplary first low-frequency sub-signal separated from the signal of FIG. 3A according to the present invention;

FIG. 3C is an exemplary first high-frequency sub-signal separated from the signal of FIG. 3A according to the present invention;

FIG. 3D is an exemplary second low-frequency sub-signal separated from the signal shown in FIG. 3C according to the present invention;

FIG. 3E is an exemplary second high-frequency sub-signal remaining in the signal of FIG. 3C according to the present invention;

FIG. 3F is an exemplary third low-frequency sub-signal separated from the signal of FIG. 3E according to the present invention;

FIG. 3G is an exemplary third high-frequency sub-signal remaining in the signal shown in FIG. 3E according to the present invention;

FIG. 4A is the exemplary source signal of FIG. 1A;

FIG. 4B is an exemplary first high-frequency sub-signal separated from the signal of FIG. 4A according to the present invention;

FIG. 4C is an exemplary first low-frequency sub-signal remaining in the signal shown in FIG. 4A according to the present invention;

FIG. 4D is an exemplary second high-frequency sub-signal separated from the signal shown in FIG. 4C according to the present invention;

FIG. 4E is an exemplary second low-frequency sub-signal remaining in the signal of FIG. 4C according to the present invention;

FIG. 4F is an exemplary third high-frequency sub-signal separated from the signal of FIG. 4E according to the present invention;

FIG. 4G is an exemplary third low-frequency sub-signal remaining in the signal shown in FIG. 4E according to the present invention;

FIG. 5 is a schematic block diagram of an exemplary signal processing system according to the present invention;

FIG. 6A is the exemplary source signal of FIG. 1A including more pulses;

FIG. 6B is an exemplary low-frequency sub-signal separated from the signal shown in FIG. 6A according to the present invention;

FIG. 6C is an exemplary high-frequency sub-signal remaining in the signal of FIG. 6A according to the present invention;

FIG. 6D is an exemplary low-frequency expanded sub-signal for the signal shown in FIG. 6A appending a half-pulse of the same segment according to the present invention;

FIG. 6E is another exemplary low-frequency expanded sub-signal for the signal shown in FIG. 6A appending a vertically shifted half-pulse of the same segment according to the present invention;

FIG. 6F is another exemplary low-frequency expanded sub-signal for the signal shown in FIG. 6A appending a half-pulse of a neighboring segment according to the present invention;

FIG. 6G is another exemplary low-frequency expanded sub-signal for the signal shown in FIG. 6A appending a half-pulse scaled by another half-pulse of the same segment according to the present invention;

FIG. 6H is another exemplary low-frequency expanded sub-signal for the signal shown in FIG. 6A appending a half-pulse scaled by another half-pulse of a neighboring segment according to the present invention;

FIG. 6I is another exemplary low-frequency expanded sub-signal for the signal shown in FIG. 6A appending average half-pulses of neighboring half-pulses of the same phase angle according to the present invention;

FIG. 6J is another exemplary low-frequency expanded sub-signal for the signal shown in FIG. 6A appending an average pulse of neighboring segments according to the present invention;

FIG. 7A is the exemplary high-frequency sub-signal of FIG. 6C;

FIG. 7B is an exemplary high-frequency expanded sub-signal for the signal shown in FIG. 7A appending a pulse of the same segment according to the present invention;

FIG. 7C is another exemplary high-frequency expanded sub-signal for the signal shown in FIG. 7A appending two pulses and one half-pulse of the same segment according to the present invention;

FIG. 7D is another exemplary high-frequency expanded sub-signal for the signal shown in FIG. 7A appending an entire segment thereonto according to the present invention; and

FIG. 7E is another exemplary high-frequency expanded sub-signal for the signal shown in FIG. 7A defining a longer expansion interval and also appending an entire segment thereonto according to the present invention.

### DETAILED DESCRIPTION OF THE PREFERRED EMBODIMENTS

The present invention generally relates to various discrete time scaling systems and methods for expanding a source signal along a time axis while at least substantially preserving its frequency distribution and also obviating a need to smoothen an expanded signal. More particularly, the present invention relates to a time scaling system for extending the source signal by a preset expansion ratio, where the system typically includes a signal separation unit for dividing the source signal into multiple component signals each of which is characterized by a different range of frequency (or bandwidth), an expansion unit for expanding each component signal by the expansion ratio, and an output unit for combining the expanded component signals to generate the expanded signal. With such a time scaling system, an user may expand the source signal by one of preset expansion ratios which may be any positive integer or any real number which may be represented by a ratio of m to n or another ratio of (m+0.5) to n where m and n are positive integers and where n is not less than m. Such a time scaling system of the present invention may be characterized by its expansion unit which may separate each component signal into multiple segments starting and terminating at identical (or at least substantially similar) amplitudes and which may append to such segments at least portion thereof also starting and terminating at identical (or at least substantially similar) amplitudes. Therefore, the time scaling system of this invention may provide the expanded signal without any audible distortion, thereby obviating the need to rigorous signal smoothening algorithms. The present invention also relates to various methods of expanding the source signal by separating the source signal into multiple component signals each characterized by a different range of frequency (or bandwidth), by expanding each of the component signals using different intervals of expansion, and by generating the expanded signal by superposition (or summation) of each of such expanded component signals. The present invention further relates to various algorithms for such time scaling as well as various processes for providing such time scaling systems.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

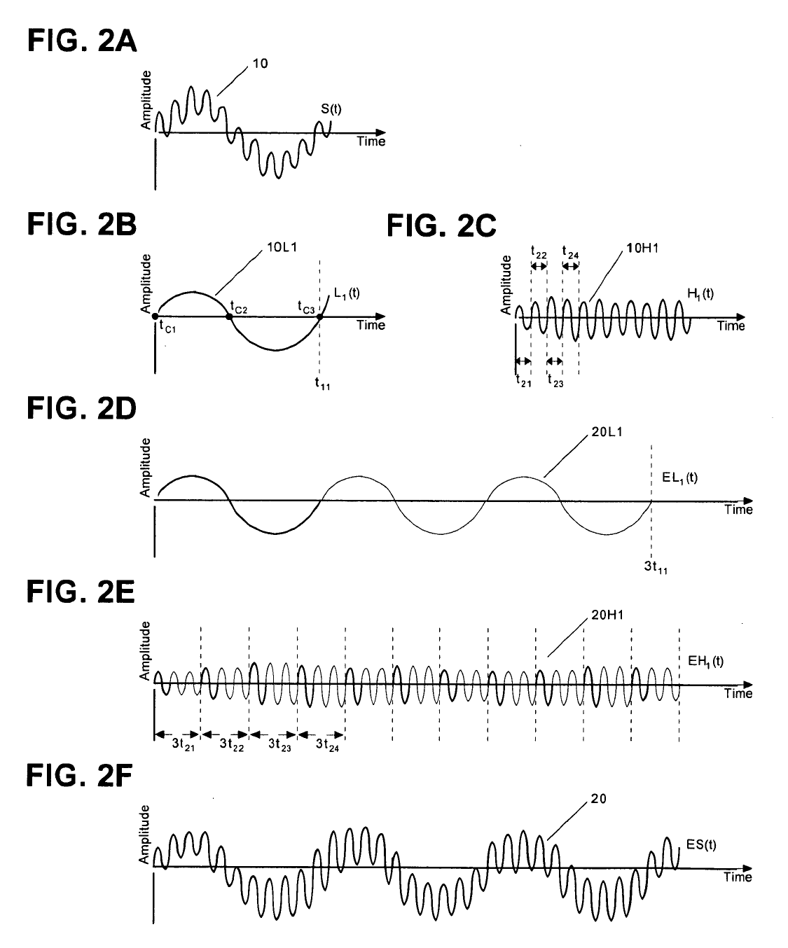

In one aspect of the present invention, a signal processing system may be arranged to expand a source signal having multiple pulses therealong into an expanded signal by a preset expansion ratio while at least substantially preserving (or maintaining) frequency distribution of such a source signal in the expanded signal and/or at least substantially preventing (or minimizing) formation (or generation) of discontinuities along such an expanded signal. The system may be arranged to divide the source signal into a fixed preset number of sub-signals each of which may include multiple pulses in one of multiple preset ranges of frequency. FIGS. 2A through 2F describe various signals obtained by such a system of this aspect of the present invention.

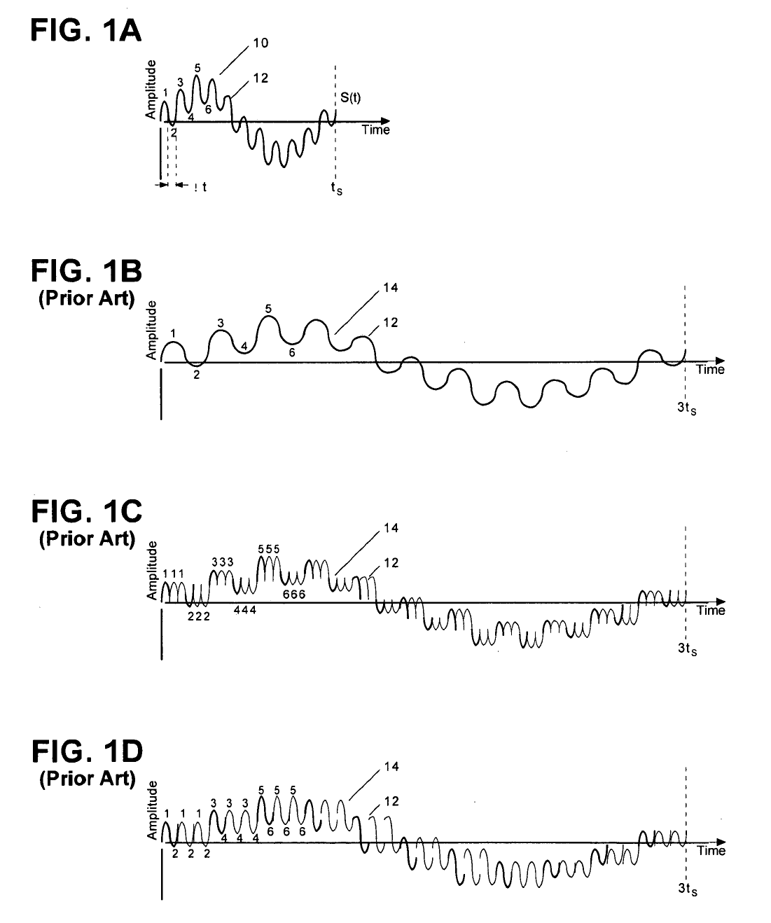

FIG. 2A is the exemplary source signal shown in FIG. 1A, FIG. 2B depicts an exemplary low-frequency sub-signal separated from the source signal of FIG. 2A, and FIG. 2C is an exemplary high-frequency sub-signal remaining in the source signal of FIG. 2A according to the present invention. It is to be understood that FIG. 2A shows only a small portion of a source signal 10 for ease of illustration. An exemplary signal processing system is arranged to divide the source signal 10 [S(t)] into a pair of sub-signals, where the first one is a first low-frequency sub-signal 10L1 [L₁(t)], while the second one is a first high-frequency sub-signal 10H1 [H₁(t)]. Because the sub-signals 10L1, 10L2 may be added or superposed one over the other, they satisfy the Equation (1a) within a preset error range:

S(t)=L₁(t)+H₁(t) (1a)

It is appreciated that such a low-frequency sub-signal 10L1 typically consists of a single pulse which may be a sinusoid or a quasi-sinusoid and which starts from an origin or a first crossover (referred to as t_{C1}), increases to its local peak, decreases therefrom, crosses over a preset baseline (such as the time axis at zero amplitude in this embodiment) at a second crossover (represented by t_{C2}), reaches its valley, increases therefrom, and then crosses over the baseline at a third crossover (denoted as t_{C3}). In contrary, the high-frequency sub-signal 10H1 consists of multiple pulses which may be sinusoids or quasi-sinusoids and each of which oscillates or fluctuates across the baseline by starting at a first crossover, increasing to its local peak, decreasing therefrom, crossing over the baseline, reaching its valley, increasing therefrom, and crossing over the baseline at a third crossover.

After locating the crossovers for each sub-signal 10L1, 10H1, the system is arranged to divide each sub-signal 10L1, 10H1 into multiple segments, where each segment of this embodiment includes only one pulse. For example, a typical segment of the low-frequency sub-signal 10L1 may be defined as a single pulse extending between three crossovers such as, i.e., between the first crossover (t_{C1}) and the third crossover (t_{C3}), over a length of t₁₁. Similarly, a typical segment of the high-frequency sub-signal 10H1 may be defined as a single pulse extending between three crossovers over a length of t₂₁, t₂₂, t₂₃ or t₂₄. It is to be understood that such segments of the low-frequency sub-signal 10L1 are longer than those of the high-frequency sub-signal 10H1, for each segment of such sub-signals 10L1, 10H1 is to include the same number of pulse by definition.

The system may then proceed to expand such a source signal 10 by a preset expansion ratio which is 3.0 in this embodiment. It is noted that expanding the source signal 10 by the expansion ratio of 3 corresponds to increasing a length of the signal 10 by three times or to 300% of its original length. FIG. 2D is an exemplary low-frequency expanded sub-signal of the low-frequency sub-signal of FIG. 2B, while FIG. 2E describes an exemplary high-frequency expanded sub-signal of the high-frequency sub-signal of FIG. 2C.

In the first step of the expansion, the system generates a pair of expanded sub-signals 20L1, 20H1 by expanding each segment of each sub-signal 10L1, 10H1 by the same expansion ratio of 3.0. For example, each segment of the low-frequency sub-signal 10L1 is appended by two of the identical segments as depicted in FIG. 2D, thereby generating the expanded low-frequency sub-signal 20L1. It is appreciated that each expanded segment has a length which is exactly three times the length of the original signal and, therefore, that such an expanded sub-signal 20L1 also has a length which is three times the length of the original sub-signal 10L1. It is appreciated in the expanded signal 20L1 that the first pulse in a solid line shows the segment of the original sub-signal 10L1, while the second and third pulses in hair lines are two appended segments. Similarly, each segment of the high-frequency sub-signal 10H1 is appended by two of the same segments as depicted in FIG. 2E, thereby generating the expanded high-frequency 20H1. Because each expanded segment has a length which is three times the length of the original segment, the expanded sub-signal 20H1 similarly has a length which is three times the length of the original sub-signal 10H1. In addition, the pulses in solid and hair lines similarly represent the segments of the original sub-signal 10H1 and appended segments, respectively.

In the next step of the expansion, the system generates an expanded signal 20 by combining, adding or superposing all of the expanded sub-signals 20L1, 20H1 one over the other. For example, FIG. 2F shows an exemplary expanded signal of the exemplary source signal of FIG. 2A according to the present invention. Because these expanded sub-signals 20L1, 20L2 may be added, combined or superposed one over the other, they may generate the expanded signal 20 which always satisfy the following Equation (1b):

ES(t)=EL₁(t)+EH₁(t) (1b)

The signal processing system of this invention offers numerous advantages over conventional cut-and splice algorithms. First, the system divides the sub-signals into the segments and manipulates each segment, where the lengths of such segments are generally dependent on the frequency of the pulses included in such segments. Accordingly, the expanded signal provided by such a system may have a better chance of at least substantially preserving the frequency characteristics of the source signal therein. In addition, such a system is arranged to expand each segment of such sub-signals by append the same segment thereto. Because each segment of each sub-signal is defined to start and terminate at the same amplitude, each of the expanded segments is also arranged to start and then to end at the same amplitude and, therefore, each sub-signal may be expanded by the preset expansion ratio without introducing any discontinuity in amplitudes. It is then guaranteed that the expanded signal which is a summation of all of the expanded sub-signal does not form any discontinuity either.

The resulting advantage of the system of the present invention is manifest in FIG. 2F, i.e., such an expanded signal consists of the expanded low-frequency sub-signal of FIG. 2D superposed by the expanded high-frequency sub-signal of FIG. 2E. Accordingly, an initial portion of the expanded signal includes the original low-frequency sub-signal superposed with an initial one third portion of the high-frequency sub-signal of FIG. 2C, a middle portion of the expanded signal includes the appended low-frequency sub-signal superposed with a middle on-third portion of the high-frequency sub-signal, and then a last portion of the expanded signal consists of the second appended low-frequency sub-signal superposed by a last on-third portion of the high-frequency sub-signal. It is to be understood that the expanded signal of FIG. 2F is different from another signal obtained by appending the source signal of FIG. 2A twice thereafter, for the latter signal cannot preserve the frequency distribution of the source signal. That is, all of the high-frequency pulses are repeated individually in the expanded signal while maintaining the frequency sequence of the source signal, whereas such pulses are to be repeated as a whole by three times in the latter signal, thereby distorting such frequency sequence of the source signal.

It is appreciated that the above system may find limited use, for some source signals may have multiple harmonic components and, accordingly, division of such signals into only two sub-signals may not always guarantee quality of the expanded signal. Even when the system is arranged to divide the source signal into more than two sub-signals such as, e.g., 4, 6, 8, 12, 16, 32, 64, 128, and the like. It is noted that adoption of more number of sub-signals may not always be beneficial, for such a system may require perform an unduly large amount of signal processing. In addition, adopting a fixed number and then dividing the source signal into such a number of sub-signals may not always guarantee that the expanded signal will have the required quality.

In general, a chance of generating the satisfactory expanded signal may be assessed prior to performing requisite signal processing using several prognostic features. One of such features may be shapes and/or sizes of such pulses of the sub-signals or, more specifically, the vertical symmetry of such pulses. It is appreciated that heights and depths of such pulses are generally determined by amplitudes thereof and, accordingly, may vary depending upon dynamic characteristics of the source signal. However, comparison of the heights and depths of a single pulse and/or neighboring pulses of the sub-signals may serve as the prognostic feature, because adjacent pulses of the source signal which are obtained at a preset sampling rate over a certain limit and which represent the same sound should be at least substantially similar or identical to each other. Therefore, such vertical symmetry of the single pulse and/or neighboring pulses may serve as one criterion whether the source signal has been divided into an optimum number of sub-signals. If any of the sub-signals may fail to satisfy the criterion, such a sub-signal may be further divided into two or more sub-signals in each of which its pulses may meet the criterion. A variety of configurational characteristics of the pulses may be used to assess such vertical symmetry, where examples of such characteristics may include, but not be limited to, a difference between the height and depth of one pulse, a ratio of the height to the depth, a difference between the above differences and/or ratios of two or more adjacent or adjoining pulses, a ratio of the above difference and/or ratio of one pulse to those of the adjacent or adjoining pulse, a difference between areas of an upward half-pulse and a downward half-pulse of a pulse, a ratio of the areas of such upward and downward half-pulses, a difference between the above differences and/or ratios of such areas of two or more adjacent or adjoining pulses, and the like. It is appreciated that such heights, depths, and/or areas are to be assessed with respect to the preset baseline which may be the time axis with zero-amplitude or another horizontal axis with a nonzero amplitude. Other configurational characteristics connoting the shapes and/or sizes of such pulses may be used as the prognostic feature as well.

Another prognostic feature may also be the shapes and/or sizes of such pulses of such sub-signals or, more specifically, horizontal symmetry of the pulses. It is to be understood that lengths of such pulses are generally determined by frequencies thereof and, accordingly, may vary depending upon frequency characteristics of the source signal. However, comparison of the lengths between various landmarks of a single pulse and/or neighboring pulses of the sub-signals may also serve as the prognostic feature, because adjacent pulses of the source signal should be at least substantially similar or identical to each other due to the similar reason described hereinabove. Accordingly, such horizontal symmetry of the single pulse and/or neighboring pulses may also serve as another criterion whether the source signal has been divided into an optimum number of sub-signals. If any of the sub-signals may fail to satisfy the criterion, such a sub-signal may be further divided into two or more sub-signals in each of which its pulses may meet the criterion. Various temporal characteristics of a pulse may be used as the landmarks examples of which may include, but not be limited to, a starting time or a timing of a first crossover of the pulse with respect to the preset baseline, an ending time or a timing of a last crossover thereof, a timing of a middle crossover thereof, a timing of a peak thereof, a timing of a valley thereof, a timing of a point in which a second derivative of such a pulse is zero, and so on. Various configurational characteristics of the pulses may be used to assess the horizontal symmetry, where examples of such configurational characteristics may include, but not be limited to, a distance between (or a ratio of) an interval between the first and middle crossovers and interval between the middle and last crossovers, a distance between (or a ratio of) an interval between the first crossover and peak and an interval between the peak and middle crossover, a distance (or ratio) between an interval between other landmarks described above, and the like. It is noted that these characteristics are generally used to assess the horizontal symmetry within a single pulse. Such characteristics may also include a difference (or a ratio) between the distance between such intervals of one pulse and the distance between such intervals of an adjacent pulse in order It is to be understood that these characteristics may be used to assess the horizontal symmetry between two adjacent pulses. Other configurational characteristics connoting the temporal events of such pulses may also be used as the prognostic feature.

Another prognostic feature relates to curvature of such pulses, more specifically, presence of absence of spikes and/or superposition of other harmonic components in different frequency range. When a given sub-signal preferentially consists of pulses with a narrow range of frequency, such a sub-signal may be viewed as a harmonic component of the source signal having a shape of a typical sinusoid. Therefore, its contour such as, e.g., its first derivative may also be approximated as another sinusoid. However, when such a sub-signal is preferentially a composite waveform in which at least two groups of pulses in different ranges of frequency may be superposed one over the other, such a sub-signal has a curvature which is not a sinusoid and, occasionally, forms small bumps therealong. Therefore, various characteristics of the curvature of the pulses of a given sub-signal may be used to assess whether or not the sub-signals need to be further separated into next-generation sub-signals. Examples of such characteristics may include, but not limited to, a profile (e.g., monotonous increase or decrease) of a first derivative of the pulse between two of such above landmarks, another profile (e.g., a sign change) of a second derivative of the pulse between such landmarks, fluctuation of the pulse between such landmarks, and the like.

It is to be understood that an optimum number of sub-signals may depend upon various factors such as, e.g., a sampling rate of the source signal, a number of bandwidths or ranges of frequencies employed in generating the sub-signals, an extent of each of such ranges of frequencies, and the like. For example, when the source signal is obtained (or digitized) at a low sampling rate, adjacent pulses of lower sub-signal may actually account for different sounds and comparison of various features of these pulses may not be an adequate indicator for assessing the vertical and/or horizontal symmetry and/or curvature. Therefore, care should be taken in selecting such prognostic features. In general, a normal human ear may perceive waveforms falling in a frequency range from 16 Hz to 20,000 Hz. In addition, most musical instruments including human vocal cords are typically limited in speed so that it is not feasible to generate more than a few or at most several different sounds per second. These facts should be accounted for when selecting the foregoing prognostic features and assessing such vertical symmetry, horizontal symmetry, and/or curvature of the pulses of each sub-signal.

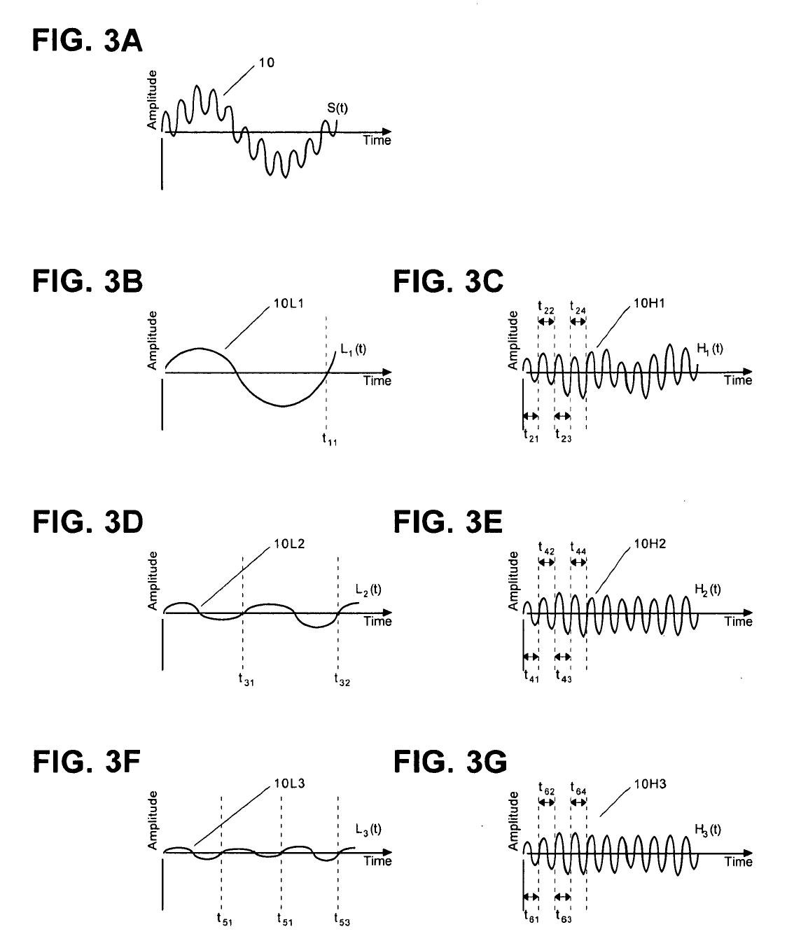

In another aspect of the present invention, another signal processing system may be arranged to divide a source signal including multiple pulses therealong into an optimum number of sub-signals, to expand each sub-signal by a preset expansion ratio, and to provide an expanded signal by combining all expanded sub-signals, while at least substantially preserving (or maintaining) frequency distribution of such a source signal in the expanded signal and/or at least substantially preventing (or minimizing) formation (or generation) of discontinuities along the expanded signal. Such a system may preferably employ one or more of the above prognostic features in providing the optimum number of sub-signals, and then divide the source signal into such a number of sub-signals each of which may have multiple pulses in one of multiple preset ranges of frequency. FIGS. 3A to 3G show various signals obtained by the system of such an aspect of this invention.

FIG. 3A is the exemplary source signal similar to that of FIG. 1A, FIG. 3B shows an exemplary first low-frequency sub-signal separated from the source signal of FIG. 3A, while FIG. 3C depicts an exemplary first high-frequency sub-signal remaining in the source signal of FIG. 3A according to the present invention. It is to be understood that FIG. 3A shows only a small portion of a source signal 10 for ease of illustration. Similar to that of FIGS. 2A through 2F, an exemplary signal processing system divides the source signal 10 [S(t)] into a first low-frequency signal 10L1 [L₁(t)] as well as a first high-frequency sub-signal 10H1 [H₁(t)] such that:

S(t)=L₁(t)+H₁(t) (1a)

The system may then use one or more of the above prognostic features in order to assess the vertical symmetry of the pulses, horizontal symmetry thereof, and/or curvature thereof for each sub-signal 10L1, 10H1. As long as the pulses of the sub-signals 10L1, 10H1 satisfy the preset criteria, the system proceeds to expand the source signal by the preset expansion ratio by manipulating each of the sub-signals 10L1, 10H1 similar to the procedures as described in conjunction with FIGS. 2A to 2F.

However, one of the sub-signals such as, e.g., the first high-frequency sub-signal 10H1, may not meet, e.g., the vertical symmetry. In this case, the system may divide the first high-frequency sub-signal 10 [H₁(t)] into a second low-frequency signal 10L2 [L₂(t)] as well as a second high-frequency sub-signal 10H2 [H₂(t)]. Such a case is described in FIGS. 3D and 3E., where FIG. 3D is an exemplary second low-frequency sub-signal separated from the sub-signal of FIG. 3C, while FIG. 3E shows an exemplary second high-frequency sub-signal remaining in the sub-signal of FIG. 3C according to the present invention. The two second-generation sub-signals 10L2, 10H2 may also be superposed one over the other such that:

H₁(t)=L₂(t)+H₂(t) (2a)

The system may again employ one or more of the above prognostic features and assess the vertical symmetry of the pulses, horizontal symmetry thereof, and/or curvature thereof for another next pair of sub-signal 10L2, 10H2. When the pulses of each sub-signal 10L2, 10H2 satisfy the preset criteria, the system may proceed to expand the source signal by the expansion ratio while manipulating each of the three sub-signals 10L1, 10L2, 10H2 similar to the procedures as described in conjunction with FIGS. 2A to 2F.

However, one of such sub-signals such as, e.g., the second high-frequency sub-signal 10H2 may again fail to satisfy one of the foregoing criteria. In this case, the system may further divide the second high-frequency sub-signal 10 [H₂(t)] into a third low-frequency signal 10L2 [L₃(t)] as well as a third high-frequency sub-signal 10H2 [H₂(t)]. This case is also described in FIGS. 3F and 3G., where FIG. 3F is an exemplary third low-frequency sub-signal separated from the signal of FIG. 3E, and FIG. 3G is an exemplary third high-frequency sub-signal remaining in the signal shown in FIG. 3E according to the present invention. These two third-generation sub-signals 10L3, 10H3 may also be superposed one over the other such that:

H₂(t)=L₂(t)+H₃(t) (2b)

The system may again employ one or more of the above prognostic features and assess the vertical symmetry, horizontal symmetry, and/or curvature for the pair of the third-generation sub-signal 10L3, 10H3. When the pulses of these third-generation sub-signals 10L3, 10H3 may not satisfy the preset criteria, the system may divide such a sub-signal into a pair of fourth-generation sub-signals, and the like. However, when such third-generation sub-signals 10L3, 10H3 meet the preset criteria which is assumed to the case, the system may proceed to expand the source signal by the expansion ratio.

First, it is to be understood that the original source signal 10 may be represented as a sum of its harmonic components such as the first-, second-, and third-generation sub-signals within a preset error range according to the Equation (2c):

S(t)=L₁(t)+H₁(t)=L₁(t)+L₂(t)+H₂(t)=L₁(t)+L₂(t)+L₃(t)+H₃(t) (2c)

Accordingly, the system locates crossovers in each of the above four sub-signals 10L1, 10L2, 10L3, 10H3 with respect to the same baseline such as the zero-amplitude time axis or a horizontal axis with a nonzero amplitude for all of such sub-signals 10L1, 10L2, 10L3, 10H3 or, alternatively, with respect to different baselines for at least two of such sub-signals 10L1, 10L2, 10L3, 10H3. Thereafter, such a system divides each sub-signal 10L1, 10L2, 10L3, 10H3 into multiple segments, where each of such segments may include a single pulse or a preset number of multiple pulses therein.

The system may proceed to expand each segment of each sub-signal 10L1, 10L2, 10L3, 10H3 by the preset expansion ratio similar to the algorithm described in conjunction with FIGS. 2A to 2F, and align such expanded segments for each sub-signal 10L1, 10L2, 10L3, 10H3, thereby generating each of the expanded sub-signals. Thereafter, the system superposes the expanded sub-signals one over the other, thereby generating the expanded signal.

In another aspect of the present invention, another signal processing system may be arranged to expand a source signal into an expanded signal by an expansion ratio, similar to the one exemplified in the preceding aspect. Accordingly, such a system may at least substantially preserve (or maintain) frequency distribution of the source signal in the expanded signal and/or at least substantially prevent (or minimize) formation or generation of discontinuities in the expanded signal. Contrary to the system which separates the low-frequency sub-signals until the remaining high-frequency sub-signal until the remaining sub-signal satisfies the preset criterion as illustrated in the preceding aspect, the system of this aspect of the present invention is rather arranged to separate high-frequency sub-signals until a remaining low-frequency sub-signal satisfies the preset criterion. FIGS. 3A to 3G are various signals obtained by the system of such an aspect of this invention.

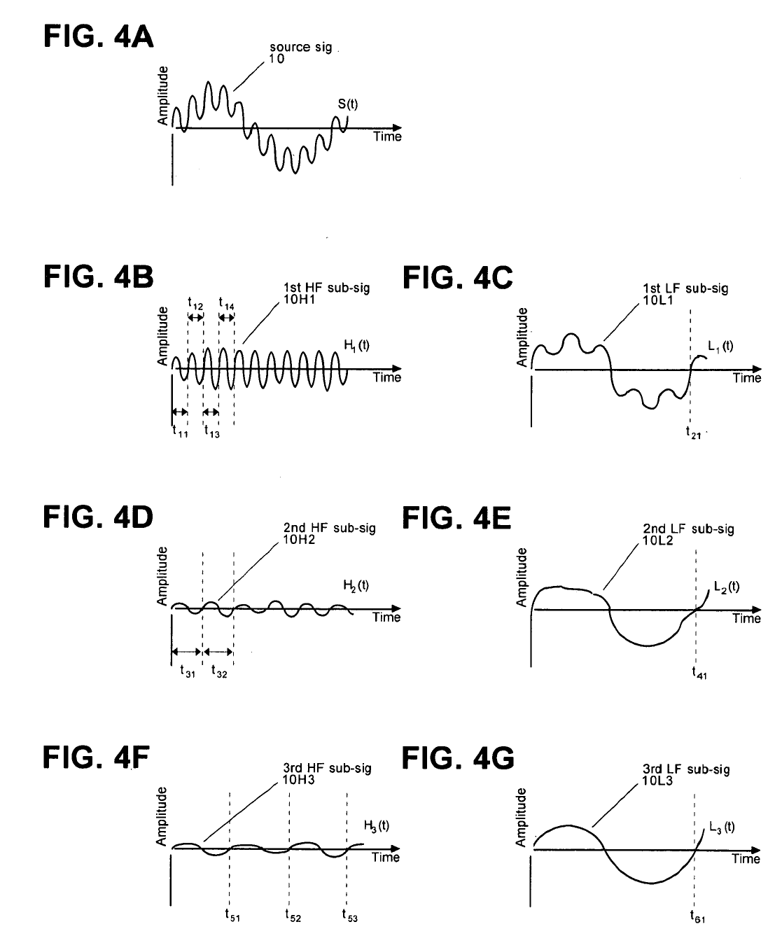

FIG. 4A is the exemplary source signal similar to that of FIG. 1A, FIG. 4B shows an exemplary first high-frequency sub-signal separated from the source signal of FIG. 4A, while FIG. 4C depicts an exemplary first low-frequency sub-signal remaining in the source signal of FIG. 4A according to the present invention. It is to be understood that FIG. 4A shows only a small portion of a source signal 10 for ease of illustration. Similar to that of FIGS. 2A through 2F, an exemplary signal processing system divides the source signal 10 [S(t)] into a first high-frequency signal 10H1 [H₁(t)] as well as a first low-frequency sub-signal 10L1 [L₁(t)] such that:

S(t)=H₁(t)+L₁(t) (3a)

The system may then use one or more of the above prognostic features in order to assess the vertical symmetry of the pulses, horizontal symmetry thereof, and/or curvature thereof for each sub-signal 10H1, 10L1. As long as the pulses of the sub-signals 10H1, 10L1 satisfy the preset criteria, the system proceeds to expand the source signal by a preset expansion ratio by manipulating each of the sub-signals 10H1, 10L1 similar to the procedures as described in conjunction with FIGS. 2A to 2F.

However, one of the sub-signals such as, e.g., the first low-frequency sub-signal 10L1, may not meet, e.g., the vertical symmetry, horizontal symmetry, and/or curvature. In this case, the system divides the first low-frequency sub-signal 10L1 [L₁(t)] into a second high-frequency sub-signal 10H2 [H₂(t)] as well as a second low-frequency sub-signal 10H2 [H₂(t)], which is described in FIGS. 3D and 3E where FIG. 4D is an exemplary second high-frequency sub-signal separated from the sub-signal of FIG. 4C and FIG. 4E is an exemplary second low-frequency sub-signal 10L2 [L₂(t)] remaining in the sub-signal of FIG. 4C according to the present invention. These two second-generation sub-signals 10H2, 10L2 may also be superposed one over the other such that:

L₁(t)=H₂(t)+L₂(t) (3b)

The system may again employ one or more of the above prognostic features and assess the vertical symmetry of the pulses, horizontal symmetry thereof, and/or curvature thereof for another next pair of sub-signal 10H2, 10L2. When the pulses of each sub-signal 10H2, 10L2 satisfy the preset criteria, the system may proceed to expand the source signal by the expansion ratio while manipulating each of the three sub-signals 10H1, 10H2, 10L2 similar to the procedures as described in conjunction with FIGS. 2A to 2F.

However, one of such sub-signals such as, e.g., the second high-frequency sub-signal 10L2 may again fail to satisfy one of the foregoing criteria. In this case, the system may further divide the second low-frequency sub-signal 10L2 [L₂(t)] into a third high-frequency signal 10H2 [H₃(t)] a third low-frequency sub-signal 10L2 [L₃(t)]. This case is also described in FIGS. 4F and 4G., where FIG. 4F is an exemplary third high-frequency sub-signal separated from the signal of FIG. 4E, and FIG. 4G is an exemplary third low-frequency sub-signal remaining in the signal shown in FIG. 4E according to the present invention. These two third-generation sub-signals 10H3, 10L3 may also be superposed one over the other such that:

L₂(t)=H₃(t)+L₃(t) (3c)

The system may again employ one or more of the above prognostic features and assess the vertical symmetry, horizontal symmetry, and/or curvature for the pair of the third-generation sub-signal 10H3, 10L3. When the pulses of these third-generation sub-signals 10H3, 10L3 may not satisfy the preset criteria, the system may divide such a sub-signal into a pair of fourth-generation sub-signals, and the like. However, when such third-generation sub-signals 10H3, 10L3 meet the preset criteria which is assumed to the case, the system may proceed to expand the source signal by the expansion ratio.

First, it is to be understood that the original source signal 10 may be represented as a sum of its harmonic components such as the first-, second-, and third-generation sub-signals within a preset error range according to the Equation (3d):

S(t)=H₁(t)+L₁(t)=H₁(t)+H₂(t)+L₂(t)=H₁(t)+H₂(t)+H₃(t)+L₁(t) (3d)

Accordingly, the system locates crossovers in each of the above four sub-signals 10H1, 10H2, 10H3, 10L3 with respect to the same baseline such as the zero-amplitude time axis or a horizontal axis with a nonzero amplitude for all of such sub-signals 10H1, 10H2, 10H3, 10L3 or, alternatively, with respect to different baselines for at least two of such sub-signals 10H1, 10H2, 10H3, 10L3. Thereafter, such a system divides each sub-signal 10H1, 10H2, 10H3, 10L3 into multiple segments, where each of the segments may include a single pulse or a preset number of multiple pulses therein.

The system may proceed to expand each segment of each sub-signal 10H1, 10H2, 10H3, 10L3 by the preset expansion ratio similar to the algorithm described in conjunction with FIGS. 2A to 2F, and align such expanded segments for each sub-signal 10H1, 10H2, 10H3, 10L3, thereby generating each of the expanded sub-signals. Thereafter, the system superposes the expanded sub-signals one over the other, thereby generating the expanded signal.

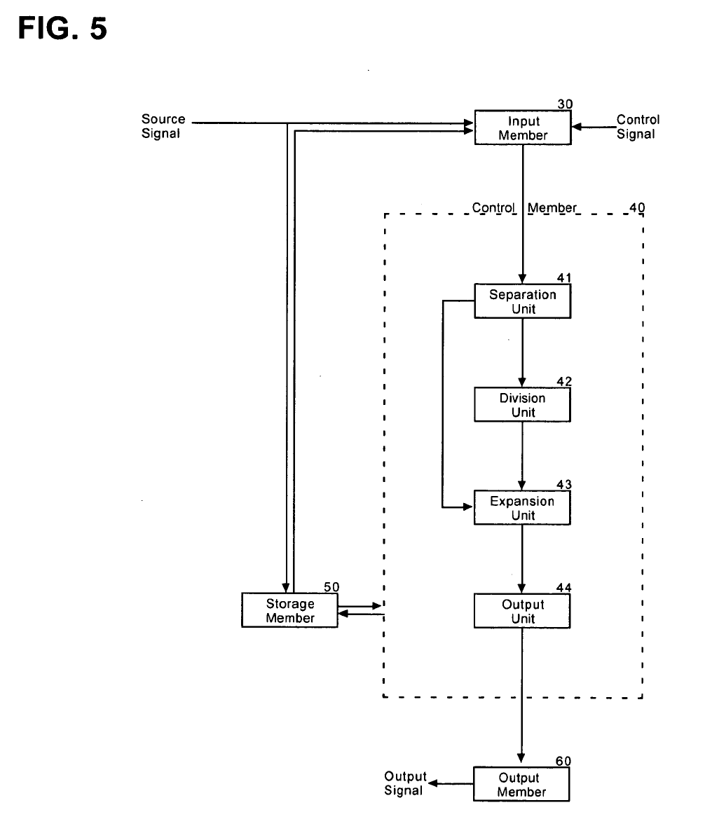

Various signal processing systems may be provided for various algorithms for expanding the source signal as described hereinabove and as will be provided hereinafter. Although such systems may be provided in various configurations, they generally involve several common members. FIG. 5 is a schematic block diagram of an exemplary signal processing system for expanding the source signal according to the present invention, where the system typically includes at least one input member 30, at least one control member 40, at least one storage member 50, and at least one output member 60.

The input member 30 is arranged to receive various signals required for the signal expanding operations. Accordingly, such an input member 30 may receive a source signal directly from an user and/or through an external device which may generate or store the source signal and then deliver the source signal thereto. As defined above, such a source signal may be an electrical or optical signal, and may also be an analog or digital signal.

Such an input member 30 may also be arranged to receive various control signals from various sources. For example, the input member 30 may receive various control signals from the user, where examples of such control signals may include, but not be limited to, a signal representing an expansion ratio, another signal controlling one or more ranges of frequency for one or more sub-signals, another signal representing a number of sub-signals to be separated from the source signal, and other signals for controlling details of the signal expansion algorithms.

The input member 30 operatively couples with the control member 40 which may in turn include at least one separation unit 41, at least one optional division unit 42, at least one expansion unit, and at leas one output unit.

Such a separation unit 41 is operatively coupled to the input member 30 in order to receive the source signal therefrom. The separation unit 41 is arranged to separate at least one sub-signal from the source signal, while forming another sub-signal from the remaining portions of the source signal. As described hereinabove, the separation unit 41 may be arranged to assess whether each of such sub-signals may satisfy any of the above vertical symmetry, horizontal symmetry, curvature, and so on. To this end, the separation unit 41 may be arranged to store information for various preset criteria therein or at least to be able to access such criteria stored in other parts of the system.

In order to separate component harmonics from the source signal and to generate therefrom at least two sub-signals, the separation unit 41 may preferably be arranged to be equipped one or more of conventional harmonic analysis algorithms such as, e.g., a Fourier analyzer or transformer, a fast Fourier analyzer or transformer, a discrete Fourier analyzer or transformer, and so on. Such a unit 41 may be equipped with other conventional algorithms such as, e.g., high-pass filters, low-pass filters, and the like, in order to pass only those harmonic components including the pulses in the preset range of frequency. It is appreciated that the above analyzers, transformers, and/or filters may be arranged to perform the above analysis at least substantially real time (or instantaneously) as different portions of the source signal may be successively supplied to such a separation unit 41 or, in the alternative, to perform the harmonic analysis when the entire source signal is supplied to such a unit 41. It is also appreciated that such a separation unit 41 may be equipped with other conventional algorithms which may perform the above harmonic analysis through various analyzers or transformers not employing the Fourier analysis or transformation.

The optional division unit 42 may be operatively coupled to the separation unit 41 and receive multiple sub-signals therefrom. The division unit 42 may be arranged to identify or locate crossovers of each sub-signal with respect to the preset baseline and then to divide each sub-signal into multiple segments based upon such crossovers. As described above, the division unit 42 may be arranged to form the segments by, e.g., arranging the segments of the lower-frequency sub-signal longer than the segments of the higher-frequency sub-signal, allocating the same number of pulses in all sub-signals, including more pulses in the higher-frequency sub-signal than in the lower-frequency sub-signal, and the like.

When desirable, the division unit 42 may also be arranged to assess whether the segments of each sub-signal may satisfy a vertical symmetry, a horizontal symmetry, and/or curvature using other prognostic features. It is appreciated that such criteria for the segments are generally different from those for the pulses, in that the latter focuses upon the vertical symmetry, horizontal symmetry, and/or curvature of each pulse, while the former relates to such symmetry or curvature of each segment for each sub-signal. Accordingly, prognostic features for various criteria for the pulses may have to be modified in order to apply such to the segments. For example, the feature for pulses such as the ratio of the height to depth of a given pulse may then be modified to a segment feature such as a ratio of a maximum (or minimum) height of the pulses in a given segment to a maximum (or minimum) depth of the pulses in such a segment, a ratio of an average height of the pulses in a given segment to an average depth of the pulses of the same segment, and so on. In another example, the feature for pulses such as the ratio of the interval of the upper half-pulse to that of the lower half-pulse may be modified into a segment feature such as a ratio of a total interval of the upper half-pulses in a given segment to a total interval of the lower-half-pulses of the same segment, and the like. When such segment prognostic features do not meet the preset criteria, the segment unit 42 may be arranged to send a control signal to the separation unit 41 which may then redo the signal separation and generate another set of such sub-signals.

The division unit 42 may also receive a threshold amplitude from the control signals and identify when amplitudes of the sub-signals may fall below such a threshold. In general, this may correspond to a period of no meaningful sounds. It is appreciated that inclusion of such a null period in one of the segments may complicate extending process to be performed by the expansion unit 43, for repeating at least a portion of the segment with such a null period may form multiple null periods in the expanded signal. Accordingly, the division unit 42 may preferably be arranged to mark a starting point as well as an ending point of this null period, where such a null period may turn out to be shorter or longer than the segment. When the system is arranged to not include this division unit 42, such a task of marking the null periods may be performed by the expansion unit 43.

The expansion unit 43 may be operatively coupled to the separation and/or division units and to receive multiple sub-signals therefrom along with other control signals. Depending upon the selected mode of expansion and value of expansion ratio, the expansion unit 43 calculates appended portions each of which is arranged to be appended to a corresponding segment of each of such sub-signals. More specifically, the expansion 43 unit may first determine at least a portion of each segment which is to be used as the appended portion, where such an appended portion may consist of a single pulse of the same segment or a neighboring segment, a block of multiple successive pulses of the same or neighboring segment(s), multiple pulses selected from the same segment or neighboring segment(s), an entire portion of the same or neighboring segment, multiple of such an entire portion of the same or neighboring segment, an average of at least two pulses of the same or neighboring segment(s), one or more half-pulses of the pulse(s) of the same or neighboring segment(s) (to be described in detail below), and the like. Thereafter, the expansion unit 43 identifies one or multiple locations along each segment onto which one or more of such appended portions may be appended, where such locations may be an end portion of the segment, an initial portion thereof, a middle portion thereof, and the like.

After generating such expanded segments from the appended portions and such segments of various sub-signals, the expansion unit 43 may align the expanded segment in the same order as the original segment, thereby generating an expanded sub-signal. The expansion unit 43 may repeat this procedure for each sub-signal, thereby forming one expanded sub-signal for each of the sub-signals of the source signal.

The output unit 44 is operatively coupled to the expansion unit 43 and receives the expanded sub-signals therefrom. More specifically, the output unit 44 may simply align starting points of each of the expanded sub-signal and superpose all of such signals one over the other in order to generate the expanded signal. It is to be understood that some of such expanded segments may not be temporarily consistent, i.e., two or more expanded sub-signals may not have the identical or at least substantially similar lengths. This may easily happen when the appended pulses and/or half-pulses may not reflect true temporal characteristics of the expanded segment or, in other words, when the sub-signals may not perfectly satisfy the horizontal symmetry of the pulses. In order to prevent or at least mitigate this temporal inconsistency, the output unit 44 may be arranged to mark the landmarks of each sub-signal, to mark the corresponding landmarks of each expanded sub-signal, and to compare such landmarks against each other, thereby assessing whether each of the expanded sub-signal may be expanded by the expansion ratio. In case of the above temporal inconsistency, such an output member 44 may be arranged to adjust the lengths between such landmarks, thereby ensuring temporal consistency between the expanded segments and expanded signals. When desirable, this task may be performed by other units of the control member 40 such as, e.g., the division and/or expansion units 42, 43.

The storage member 50 may be operatively coupled to various members and/or units of such a system, store various signals received therefrom, and send such signals thereto. In one example, the storage member 50 may receive the source signal from the user and/or external device for later use. In another example, the storage member 50 may retrieve a preexisting signal and send such a signal to the input member 30 which then uses such a signal as the source signal. In another example, such an input member 30 may further receive various sub-signals, segments thereof, expanded segments, expanded sub-signals, and/or expanded signal from various units 41, 42, 43, 44 of the control member 40 and store such for later use or send such back to the control member 40. The storage member 50 may also receive, store, retrieve, and/or send one or more control signals as the same manner as the member 50 may treat other signals. Any conventional temporary or permanent storage devices may be used as the storage member 50 and, accordingly, detailed storing mechanisms and/or operational characteristics of the storage member 50 may not be material to the scope of the present invention.

Finally, the output member 60 operatively couples with the output unit 44 of the control member 40, receives the expanded signal, and generates an audible counterpart of the expanded signal. The output member 60 may be any conventional devices for generating audible signals such as speakers including diaphragms which may advance and retract from their rest positions and create the audible sound signals. Such an output member 60 may also be arranged to other members and/or units of the system and generate audible counterparts of the source signal, sub-signals thereof, segments of the sub-signals, expanded segments, expanded sub-signals, and the like.

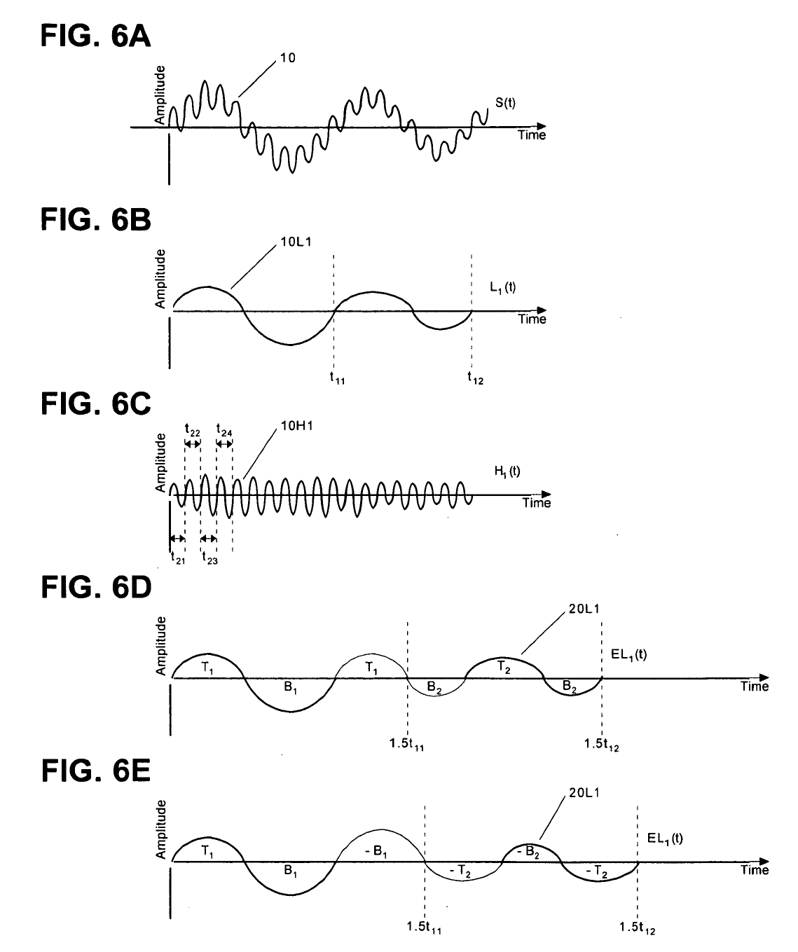

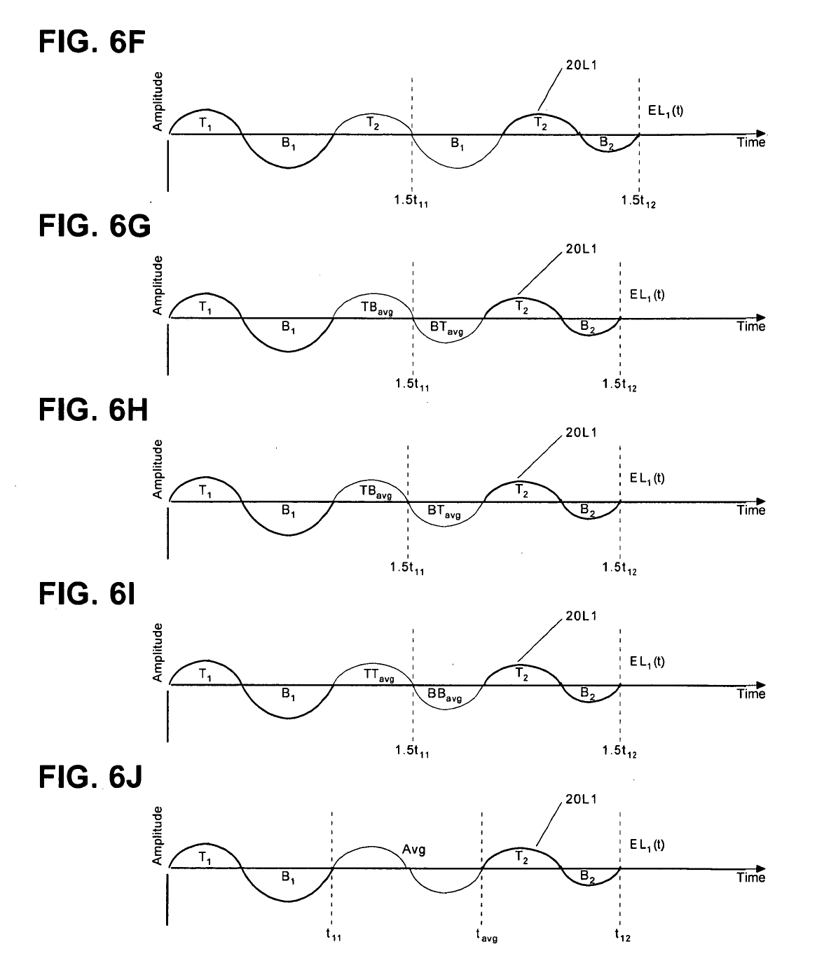

In another aspect of the present invention, another signal processing system may be arranged to divide a source signal having multiple pulses therealong into a preset or an optimum number of sub-signals, to expand each sub-signal by a preset expansion ratio, and to provide an expanded signal by combining all expanded sub-signals, while at least substantially preserving (or maintaining) frequency distribution of such a source signal in the expanded signal and/or at least substantially preventing (or minimizing) formation (or generation) of discontinuities in the expanded signal. More particularly, such a system is arranged to append at least one half-pulse into each expanded segment each of the sub-signal. Such a system may also employ one or more of the above prognostic features in providing the sub-signals. FIGS. 6A through 6J show various signals obtained by the system of such an aspect of this invention.

FIG. 6A shows the exemplary source signal of FIG. 1A including more pulses, i.e., this source signal 10 is identical to that of FIG. 1A but merely shows a longer portion of a source file of the source signal. FIG. 6B is an exemplary low-frequency sub-signal separated from the signal shown in FIG. 6A and FIG. 6C is an exemplary high-frequency sub-signal remaining in the signal of FIG. 6A according to the present invention. Similar to that of FIGS. 2A through 2F, an exemplary signal processing system divides the source signal 10 [S(t)] into a first high-frequency signal 10H1 [H₁(t)] as well as a first low-frequency sub-signal 10L1 [L₁(t)] such that:

S(t)=L₁(t)+H₁(t) (1a)

Contrary to various systems of FIGS. 2A through 4G, the signal processing system according to this aspect of the invention may rather be arranged to append half-pulses in preset locations along the sub-signals 10L1, 10H1. FIGS. 6D to 6J illustrate various exemplary embodiments of selecting and appending such half-pulses. It is appreciated that all of these exemplary embodiments correspond to an expansion ration of 1.5, i.e., expanding each segment of each sub-signal 10L1, 10H1 by 50%. It is also appreciated that FIGS. 6D to 6J only illustrate the embodiments applied to the first low-frequency sub-signal 10L1 and that identical procedures may be applied to the first high-frequency sub-signal as well.

One of the exemplary embodiments is shown in FIG. 6D which is an exemplary low-frequency expanded sub-signal for the signal of FIG. 6A appending a half-pulse of the same segment according to the present invention. In the first example in which a segment consists of a single pulse of T₁B₁, a system may select an upward half-pulse of the segment (i.e., T₁) as an appended portion and append the portion at the end of the segment, thereby expanding the original segment of T₁B₁ into an expanded segment of T₁B₁T₁. In the second example in which a segment may consist of a single pulse of T₂B₂, the system may select a downward half-pulse of the segment (i.e., B₂) as an appended portion and append the portion in front of such a segment, thereby expanding the original segment of T₂B₂ into an expanded segment of B₂T₂B₂. Therefore, the original segments may be expanded by about 50% in the examples. It is to be understood that appending one single half-pulse at the end of each segment may force a segment to end and in a phase which is typically similar to a starting phase of a next segment. Similar problem occurs by appending a single half-pulse in front of each segment as well. In order to prevent such phase inconsistency, the system may be arranged to append the half-pulses at the end of and in front of the segments in an alternating order.

Another exemplary embodiment is described in FIG. 6E which shows another exemplary low-frequency expanded sub-signal for the signal of FIG. 6A appending a vertically shifted half-pulse of the same segment according to the present invention. In its first example in which a segment consists of a single pulse of T₁B₁ a system may vertically shift a downward half-pulse of the segment, select the shifted half-pulse (i.e., B₁) as an appended portion, and append such a portion at the end of such a segment, thereby expanding the original segment of T₁B₁ into an expanded segment of −B₂T₂B₂ while maintaining the phase consistency therebetween, where a minus sign represents that the half-pulse is vertically shifted. In another example in which a segment consists of another single pulse of T₂B₂ as described in FIG. 6D, the system first vertically shifts the pulse, selects a downward half-pulse of the pulse (i.e., −T₂) as an appended portion, and append such a portion at the end of such a segment, thereby expanding the original segment of T₂B₂ into an expanded segment of −T₂−B₂−T₂. Therefore, the examples of this embodiment exemplify other algorithms for matching the phases between a given segment and an appended portion therefor as well as matching the phases of the segment with the preceding and following segments.

Another exemplary embodiment is described in FIG. 6F which represents another exemplary low-frequency expanded sub-signal for the signal of FIG. 6A appending a half-pulse of a neighboring segment according to the present invention. In the first example in which a segment may consist of a single pulse of T₁B₁, a system may select an upward half-pulse of a following segment (i.e., T₂) as an appended portion, and append the portion at the end of the segment, thereby expanding the segment of TB₁ into an expanded segment of T₁B₁T₂. In the second example in which a segment may consist of a single pulse of T₂B₂, the system may select a downward half-pulse of a preceding segment (i.e., B₂) as an appended portion and append the portion in front of such a segment, thereby expanding the segment of T₂B₂ into an expanded segment of B₂T₂B₂. Therefore, the examples of this embodiment suggest to append a composite pulse between the adjacent segments to match the phases between a given segment and an appended portion therefor and to match the phases of the segment with the preceding and following segments.

Another exemplary embodiment is described in FIG. 6G which shows another exemplary low-frequency expanded sub-signal for the signal of FIG. 6A appending a half-pulse which is scaled by another half-pulse of the same segment according to the present invention. In the first example of a segment of a pulse T₁B₁, a system may select an upward half-pulse of the segment (i.e., T₁), scale it based upon a downward pulse of the same segment (i.e., B₁), and append the scaled upward half-pulse at the end of the segment. For example, an amplitude of the upward half-pulse may be scaled by an amplitude of the downward half-pulse, a duration of the upward half-pulse may be scaled by a duration of the downward half-pulse, and the like. The scaling may correspond to a simple averaging, a weighted averaging, a geometric averaging, an ensemble averaging, and so on. When the segment may include multiple pulses therein, the ensemble averaging may offer a benefit of increasing a signal-to-noise ratio. In the second example of a segment of a pulse T₂B₂, a system may perform an inverse scaling, i.e., select a downward half-pulse of the segment (i.e., B₂), scale it based upon an upward half-pulse of the same segment (i.e., T₂), and append the scaled downward half-pulse in front of the segment. Such scaling may similarly be an amplitude or temporal scaling and performed by the above averaging algorithms. Such examples of this embodiment may be similar to those of FIG. 6F in that a composite pulse is appended between the adjacent segments, thereby matching the phases between a given segment and an appended portion therefor and matching the phases of the segment with the preceding and following segments.

A similar exemplary embodiment is described in FIG. 6H which shows another exemplary low-frequency expanded sub-signal for the signal of FIG. 6A appending a half-pulse which is scaled by another half-pulse of a neighboring segment according to the present invention. In general, a system may select one of two half-pulses from a segment of a single pulse, scale it by the similar algorithms, and append the scaled half-pulse in front of or after the segment. However, the system scales such a selected pulse of a given segment based upon amplitude and/or temporal characteristics of another half-pulse of another segment which may proceed or follow the given segment. Other configurational and/or operational characteristics of the system of FIG. 6H are generally similar or identical to those of the system of FIG. 6G.

Another exemplary embodiment is described in FIG. 6I which shows another exemplary low-frequency expanded sub-signal for the signal depicted in FIG. 6A appending average half-pulses of neighboring half-pulses of the same phase angle according to the present invention. Such a system may also select one of two half-pulses from a segment of a single pulse, scale it by one of the above algorithms, and append the scaled half-pulse in front of or after the segment. However, the system scales such a selected pulse of a given segment based on amplitude and/or temporal characteristics of another half-pulse which may belong to a preceding or following segment and which may be in the same phase as the selected pulse. Other configurational and/or operational characteristics of such a system of FIG. 6I are generally similar or identical to those of the system of FIG. 6G.

Another exemplary embodiment is described in FIG. 6J which shows another exemplary low-frequency expanded sub-signal for the signal of FIG. 6A appending an average pulse of neighboring segments according to the present invention. A system may locate a junction between the segments and identify a last pulse of a given segment and a first pulse of a following segment. The system may then calculate one of the above averages of two pulses and append such an average between such segments, thereby appending one half-pulse into an end of one segment and another half-pulse into a beginning of a next segment while preserving their phase consistency. Other configurational and/or operational characteristics of such a system of FIG. 6J are generally similar or identical to those of the system of FIG. 6G.

As described above, such systems of FIGS. 6A to 6J employ various algorithms of appending half-pulses to the segments which typically includes a single pulse therein. Such algorithms may also be applied to other segments including multiple pulses, where such a system may select a half-pulse from a beginning, an end or a middle of the identical or adjacent segment. Thereafter, the system may apply the same algorithms while positioning the appended half-pulse in the beginning, end or middle of each segment. It is appreciated that the expansion ratio of the algorithms of FIGS. 6A to 6J is typically 1.5 when the segment may include only one pulse but that the expansion ratio may become less than 1.5 when the segment may include more than one pulse and only one half-pulse is to be appended in a preset location of each segment.

Although the above expansion algorithms are preferentially applied to the low-frequency sub-signal of FIG. 6B, it is appreciated that such algorithms may be readily applicable to the high-frequency sub-signal of FIG. 6C or other sub-signals having pulses in a frequency range falling between those of FIGS. 6B and 6C.

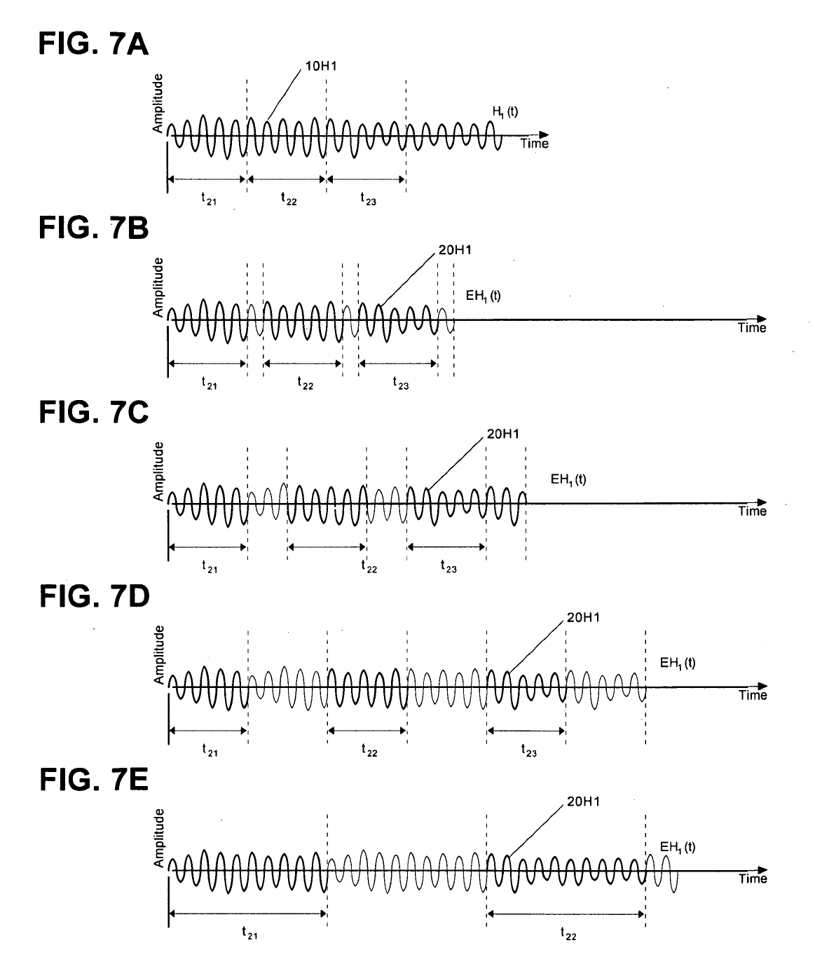

In another aspect of the present invention, another signal processing system may be arranged to divide a source signal having multiple pulses therealong into a preset or an optimum number of sub-signals, to divide each sub-signal into multiple segments each having multiple pulses, to expand each segment by a preset expansion ratio, to provide expanded sub-signals by assembling such expanded segments thereof, and to form an expanded signal by adding all expanded sub-signals, while at least substantially preserving (or maintaining) frequency distribution of the source signal in the expanded signal and/or at least substantially preventing (or minimizing) formation or generation of discontinuities in the expanded signal. More particularly, such a system is arranged to append at least one half-pulse and/or at least one pulse into each expanded segment of each of the sub-signal. Such a system may also employ one or more of the above prognostic features in providing the sub-signals. FIGS. 7A to 7J exemplify various signals obtained by the system of such an aspect of this invention, where FIG. 7A is the exemplary high-frequency sub-signal shown in FIG. 6C and where each sub-signal is divided to multiple segments each of which in turn includes five consecutive pulses therein.

A first exemplary embodiment is represented in FIG. 7B which is an exemplary high-frequency expanded sub-signal for the signal of FIG. 7A appended with a pulse of the same segment according to the present invention. In this embodiment, a system may select one pulse from a given segment and append such a pulse between the given segment and another segment preceding or following such. The system may instead select one upward half-pulse and one downward half-pulse from the given segments or, in the alternative, one upward (or downward) half-pulse from the given segment and a downward (or upward) half-pulse from another segment, combine them into a composite pulse, and append such a pulse between the given segment and another segment. Accordingly, the sub-signal may be expanded by the expansion ratio of about 1.2. It is appreciated that different pulses may also be appended into different junctions of such segments.

Another exemplary embodiment is described in FIG. 7C which is an exemplary high-frequency expanded sub-signal for the signal shown in FIG. 7A appended with two pulses and one half-pulse of the same segment according to the present invention. In this embodiment, a system may select two pulses from a given segment or, in the alternative, each pulse from two neighboring segments. Such a system may select the half-pulse from the given or neighboring segment, align two selected pulses and one selected half-pulse in a preset order, and append this appended portion to a preset location of the given segment such as, e.g., a junction between two neighboring segments. At least one of the selected pulses may also be composed by a pair of half-pulses in different phases.

Another exemplary embodiment is described in FIG. 7D which is an exemplary high-frequency expanded sub-signal for the signal of FIG. 7A appended with an entire segment thereonto according to the present invention. A system of this embodiment appends an entire portion of a given segment in front of or after such a segment, thereby expanding the segment by the expansion ratio of 2.0. Such a system is generally similar to those of FIGS. 2A to 2F, except that the segment of FIGS. 2A to 2F has a single pulse therein, whereas the segment of FIG. 7D includes multiple pulses therein.

Another exemplary embodiment is described in FIG. 7E which is an exemplary high-frequency expanded sub-signal for the signal of FIG. 7A defining a longer expansion interval and also appended with an entire segment thereonto according to the present invention. This system is similar to that of FIG. 7D, except that the sub-signal 10H1 is divided into a less number of segments such that each of the segment includes more pulses that that of FIG. 7D and, therefore, is longer than that of FIG. 7D.

Although the above expansion algorithms are preferentially applied to the high-frequency sub-signal of FIG. 6C, it is appreciated that such algorithms may be readily applicable to the high-frequency sub-signal of FIG. 6B or other sub-signals having pulses in a frequency range falling between those of FIGS. 6B and 6C.

Although the systems of FIGS. 7A to 7E are preferentially arranged to append such appended portions between the segments, the system may be arranged to append such a portion in a middle of the segment. Alternatively, the system may append different parts of the appended portion into more than one location of the segment such that, e.g., one pulse of the appended portion may be appended between the segments, while the rest of the portion may be appended in the middle of the segment. It is appreciated that, when the system may append at least one half-pulse, the next segment and/or an appended portion thereof may have to be vertically shifted in order to preserve the phase consistency between such segments.

It is appreciated the signal processing system of this aspect of the invention may expand the source signal by a variety of expansion ratios. In general, such a system may control the expansion ratio by varying a number of pulses (to be referred to as “m” hereinafter) included in a given segment, a number of pulses (to be referred to as “n: hereinafter) to be appended in at least one preset location along the segment, and/or presence or absence of a half-pulse in the appended portion for the given segment. Such expansion ratios may be represent by one of the following equations:

R_{E}=(m+n)/m (4a)

R_{E}=(m+n+0.5)/m (4b)

where the Equation (4a) refers to a case when n pulses are to be appended into at least one preset location of a segment with m pulses, while the Equation (4b) represents a case when n pulses and a single half-pulse (represented by 0.5) are to be appended to at least one preset location of a segment either together or separately. Table 1 summarizes exemplary expansion ratios obtainable by various segments and appended portions therefor, where m is a natural number, n is a non-negative integer, and n may be greater or less than m. Although Table 1 lists those numbers of m and n for expansion ratios of about 4.0, larger expansion ratios may also be obtainable by appending more pulses and/or half-pulses.

As manifest in the Table, more expansion ratios may be attainable by defining the segment to include more pulses. It is to be understood, however, that including more pulses in one segment may give rise to a danger of distorting the frequency distribution of the source signal along the expanded signal. In addition, the optimum number of pulses included in each segment may be decided by other factors such as, e.g., a frequency range of the pulses included in each segment (more pulses may be included as their frequencies get higher), a sampling or digitization rate at which the source signal is acquired (more pulses may be included as such a rate gets higher), and so on. Therefore, care must be taken in selecting the number of pulses in the segments of each sub-signal.

TABLE 1
Exemplary Expansion Ratios

| m | n | (m + n)/m | (m + n + 0.5)/m |
|---|---|---|---|
| 1 | 0 | 1.000 | 1.500 |
| 1 | 1 | 2.000 | 2.500 |
| 1 | 2 | 3.000 | 3.500 |
| 1 | 3 | 4.000 | 4.500 |
| 2 | 0 | 1.000 | 1.250 |
| 2 | 1 | 1.500 | 1.750 |
| 2 | 2 | 2.000 | 2.250 |
| 2 | 3 | 2.500 | 2.750 |
| 2 | 4 | 3.000 | 3.250 |
| 2 | 5 | 3.500 | 3.750 |
| 2 | 6 | 4.000 | 4.250 |
| 3 | 0 | 1.000 | 1.167 |
| 3 | 1 | 1.333 | 1.500 |
| 3 | 2 | 1.667 | 1.833 |
| 3 | 3 | 2.000 | 2.167 |
| 3 | 4 | 2.333 | 2.500 |
| 3 | 5 | 2.667 | 2.833 |
| 3 | 6 | 3.000 | 3.167 |
| 3 | 7 | 3.333 | 3.500 |
| 3 | 8 | 3.667 | 3.833 |
| 3 | 9 | 4.000 | 4.167 |
| 4 | 0 | 1.000 | 1.125 |
| 4 | 1 | 1.250 | 1.375 |
| 4 | 2 | 1.500 | 1.625 |
| 4 | 3 | 1.750 | 1.875 |
| 4 | 4 | 2.000 | 2.125 |
| 4 | 5 | 2.250 | 2.375 |
| 4 | 6 | 2.500 | 2.625 |
| 4 | 7 | 2.750 | 2.875 |
| 4 | 8 | 3.000 | 3.125 |
| 4 | 9 | 3.250 | 3.375 |
| 4 | 10 | 3.500 | 3.625 |
| 4 | 11 | 3.750 | 3.875 |
| 4 | 12 | 4.000 | 4.125 |
| 5 | 0 | 1.000 | 1.100 |
| 5 | 1 | 1.200 | 1.300 |
| 5 | 2 | 1.400 | 1.500 |
| 5 | 3 | 1.600 | 1.700 |
| 5 | 4 | 1.800 | 1.900 |
| 5 | 5 | 2.000 | 2.100 |
| 5 | 6 | 2.200 | 2.300 |
| 5 | 7 | 2.400 | 2.500 |
| 5 | 8 | 2.600 | 2.700 |
| 5 | 9 | 2.800 | 2.900 |
| 5 | 10 | 3.000 | 3.100 |
| 5 | 11 | 3.200 | 3.300 |
| 5 | 12 | 3.400 | 3.500 |
| 5 | 13 | 3.600 | 3.700 |
| 5 | 14 | 3.800 | 3.900 |
| 5 | 15 | 4.000 | 4.100 |
| 6 | 0 | 1.000 | 1.083 |
| 6 | 1 | 1.167 | 1.250 |
| 6 | 2 | 1.333 | 1.417 |
| 6 | 3 | 1.500 | 1.583 |
| 6 | 4 | 1.667 | 1.750 |
| 6 | 5 | 1.833 | 1.933 |
| 6 | 6 | 2.000 | 2.083 |
| 6 | 7 | 2.167 | 2.250 |
| 6 | 8 | 2.333 | 2.417 |
| 6 | 9 | 2.500 | 2.583 |
| 6 | 10 | 2.667 | 2.750 |
| 6 | 11 | 2.833 | 2.933 |
| 6 | 12 | 3.000 | 3.083 |
| 6 | 13 | 3.167 | 3.250 |
| 6 | 14 | 3.333 | 3.417 |
| 6 | 15 | 3.500 | 3.583 |
| 6 | 16 | 3.667 | 3.750 |
| 6 | 17 | 3.833 | 3.933 |
| 6 | 18 | 4.000 | 4.083 |
| 7 | 0 | 1.000 | 1.071 |
| 7 | 1 | 1.143 | 1.214 |
| 7 | 2 | 1.286 | 1.357 |
| 7 | 3 | 1.429 | 1.500 |
| 7 | 4 | 1.571 | 1.643 |
| 7 | 5 | 1.714 | 1.786 |
| 7 | 6 | 1.857 | 1.929 |
| 7 | 7 | 2.000 | 2.071 |
| 7 | 8 | 2.143 | 2.214 |
| 7 | 9 | 2.286 | 2.357 |
| 7 | 10 | 2.429 | 2.500 |
| 7 | 11 | 2.571 | 2.643 |
| 7 | 12 | 2.714 | 2.786 |
| 7 | 13 | 2.857 | 2.929 |
| 7 | 14 | 3.000 | 3.071 |
| 7 | 15 | 3.143 | 3.214 |
| 7 | 16 | 3.286 | 3.357 |
| 7 | 17 | 3.429 | 3.500 |
| 7 | 18 | 3.571 | 3.643 |
| 7 | 19 | 3.714 | 3.786 |
| 7 | 20 | 3.857 | 3.929 |
| 7 | 21 | 4.000 | 4.071 |
| 8 | 0 | 1.000 | 1.063 |
| 8 | 1 | 1.125 | 1.188 |
| 8 | 2 | 1.250 | 1.313 |
| 8 | 3 | 1.375 | 1.438 |

Configurational and/or operational variations and/or modifications of the above embodiments of the exemplary systems and various modules thereof described in FIGS. 1A through 7E also fall within the scope of this invention.

As described above, the system may separate the source signal into a preset fixed number of sub-signals or, in the alternative, to an optimum number of sub-signals where the optimum number is determined adaptively according to a preset criteria, thereby controlling the number of the sub-signals depending upon the criteria. Accordingly, when the source signal consists preferentially of pulses in a narrow frequency range, one or two sub-signals may suffice to generate the expanded signal with satisfactory quality. When the source signal turns out to be a compound signal with pulses covering a wide range of frequencies, however, the system may have to separate numerous sub-signals.

The system may divide the sub-signals into different numbers of segments depending on the ranges of frequencies of their pulses. Thus, the segments of the lower-frequency sub-signal may be longer than those of the higher-frequency sub-signal. In general, the segments of a given sub-signal may include the identical number of pulses therein. However, at least two segments of the given sub-signal may instead include different numbers of pulses. It is to be understood that a maximum number of pulses to be included in a single segment without distorting the frequency distribution of the source signal may be determined by, e.g., frequencies of the pulses, sampling rate of the source signal, and so on.

Because the segments of the higher-frequency sub-signal are generally shorter than those of the lower-frequency sub-signal, the appended portions for the former are also generally shorted than those of the latter. It is of course possible to arrange such segments of different sub-signals to have at least substantially similar lengths.

Such a system may select the ranges of frequencies of the sub-signals to be successive and mutually exclusive such that the pulses of a specific frequency range may belong to only one but not more than one of the sub-signals. In the alternative, the system may select the frequency ranges to be at most minimally overlapping such that each of a majority of such pulses may belong to only one of said sub-signals, while only some of such pulses may belong to two or more of such sub-signals.

The system may use a variety of baselines to locate the crossovers of each sub-signal. One exemplary baseline is a zero-amplitude time axis which also corresponds to a neutral or rest position of a diaphragm of a conventional speaker. Another exemplary baseline is a horizontal axis drawn at a nonzero constant amplitude. Selecting such a baseline may be beneficial when the sub-signal may be arranged to exhibit an offset over an interval selected for such a sub-signal.

The system may use a single baseline to locate the crossovers for all sub-signals and then to divide each of the sub-signals into multiple segments. In this case, both of the starting and/or ending points (or amplitudes) of the segments of all sub-signals may be at least substantially similar for all of said sub-signals. In the alternative, the system may use multiple baselines to locate the crossovers in locating the crossovers in different sub-signals and dividing such sub-signals into multiple segments.

The system may be arranged to replace at least one of the above averaged or scaled pulses by a pulse or a half-pulse which are obtained by conventional filtering or smoothening routines, cross-fading routines, interpolation or extrapolation routines, spline fitting routines, and the like. The system may also be arranged to modify at least one appended portion to match an amplitude, a first derivative, and/or a second derivative of the appended portion, respectively, with the amplitude, first derivative, and/or second derivative of its neighboring pulses. Similarly, the system may be arranged to modify at least one appended portion so as to match an actual duration of the appended portion with a required duration derived by the expansion ratio. The system may be arranged to select a pulse and/or a half-pulse of which the duration may be the closest to the required duration. The system may also insert at least one gap in at least one preset location of the segment in order to match the required duration with or without appending any appended portion.

It is to be understood that the exact number of the above members and/or units are exemplary. Accordingly, any of the above members and/or units may be arranged to perform any algorithm which has been allocated to other members and/or units in this disclosure or, conversely, any of the above algorithms may be performed by any members and/or units as long as such a system may be able to perform the same or equivalent operations. Similarly, other operational couplings between different members and/or units may be possible as long as such couplings may not interfere normal operation of the system.

Various signal processing systems of the present invention may further be arranged to focus on different aspects of expansion of the source signal. For example, the system may be arranged to focus on the frequency preservation by more strictly manipulating temporal features of the appended portions, expanded segments, expanded sub-signals, and the like. This implies that such a system is arranged to correct the temporal inconsistency between the appended portion and segment, between the neighboring expanded segments, and the like. Such a system may also be arranged to insert the gap in a preset location of the segment when manipulating the configuration of the segment may give rise to the frequency distortion. When desirable, the system may add conventional features such as, e.g., suspension, echo, and/or reverb, instead of adding the gap. In another example, the system may be arranged to focus on the rhythm or beat of the source signal by more strictly maintaining amplitude distribution thereof. Such a system may be arranged to mark certain landmarks of the source signal and compare such landmarks with those of the expanded signal while assessing discrepancy which may be more than the expansion of such by the preset expansion ratio.

Such a system may also employ various conventional signal filtering algorithms and/or devices (to be collectively referred to as filters hereinafter) so as to remove noise from various signals. Such a system may pass the source signal through the filters and remove the noise before the system may separate such a signal into multiple sub-signals. The system may pass each sub-signal through such filters in order to remove the noise before the system divides each sub-signal into multiple segments. In the alternative, the system may filter the expanded sub-signals before such expanded sub-signals may be superposed one over the other to generate the expanded signal. Finally, the system may then filter the expanded signal in order to remove any remaining noise.

As described above, the system may append half-pulses into various locations along the sub-signals. When desirable, such a system may also be arranged to manipulate a single pulse into four quarter-pulses and then directly append the quarter pulse, combine two quarter-pulses from different pulses or segments to form a half-pulse, combine four quarter-pulses selected from different pulses or segments to form a single pulse, and the like. Manipulation of such quarter-pulses may allow such a system to offer a greater variety of expansion ratios, although such quarter-pulses may introduce discontinuities when they may not start and end at the similar or identical amplitudes.

Unless otherwise specified, various features of one embodiment of one aspect of the present invention may apply interchangeably to other embodiments of the same aspect of this invention and/or embodiments of one or more of other aspects of this invention.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A signal processing system for expanding a source signal into an expanded signal by a preset expansion ratio, wherein said source signal is a pulse train having a plurality of pulses therealong and wherein said expansion ratio is a ratio of a sum of two positive integers m and n to said m so that said source signal is configured to be expanded by a percentage corresponding to a product of said n and 100 divided by said m, said system comprising:
a separation unit which is configured to obtain said source signal and to separate said source signal into a first plurality of sub-signals based upon a plurality of different ranges of frequency such that each of said sub-signals is configured to include some of said pulses having frequencies in one of said ranges;
a division unit which is configured to divide each of said sub-signals into a different number of segments, wherein one of said sub-signals including higher-frequency pulses is configured to define more segments than another of said sub-signals including lower-frequency pulses and wherein each of said segments is configured to include at least one pulse and wherein each of at least a substantial number of said segments is configured to include said m pulses therein;
an expansion unit which is configured to provide said different number of expanded segments for each of said sub-signals and then to provide said first plurality of expanded sub-signals, wherein each of at least a substantial number of said expanded segments is configured to include one of said segments having said m pulses and said n pulses of said one of said segments appended thereto and wherein each of said expanded sub-signals consists of all of its said expanded segments, thereby at least significantly preserving frequency distribution of said segments in said expanded segments; and
an output unit which is configured to superpose said expanded sub-signals one over the other and to generate said expanded signal therefrom.

2. The system of claim 1, wherein said separation unit is configured to allocate each of at least a substantial number of said pulses to only one of said sub-signals depending upon frequency of said each of at least a substantial number of said pulses.

3. The system of claim 1, wherein said separation unit is configured to allocate each of at least one of said pulses to more than one of said sub-signals depending upon frequency of said each of at least one of said pulses.

4. The system of claim 1, wherein said separation unit is configured to separate into a first sub-signal including said pulses in a first range of frequency and a first last sub-signal having a first rest of said pulses of said source signal, to assess whether said first rest of said pulses satisfy a preset criterion, and to separate said first last sub-signal into a next sub-signal including said pulses in a next range of frequency and a next last sub-signal including the next rest of of said pulses of said first last sub-signal until said next rest of said pulses satisfy said preset criterion.

5. The system of claim 4, wherein said preset criterion includes at least one of whether said rest of said pulses are configured to have their peaks over a preset baseline and their valleys below said baseline and whether a preset percentage of said rest of said pulses are configured to have at least substantially symmetric upper and lower half-pulses with respect to said baseline.

6. The system of claim 4, wherein said first range is configured to encompass a lower range of frequencies than said next range.

7. The system of claim 1, wherein said integer n is a multiple of said integer m so that a length of said expanded signal is configured to be an integer multiple of a length of said source signal.

8. The system of claim 1, wherein said integer n is not a multiple of said integer m so that a length of said expanded signal is configured to be a non-integer multiple of a length of said source signal.

9. A signal processing system for expanding a source signal into an expanded signal by a preset expansion ratio, wherein said source signal is a pulse train having a plurality of pulses therealong and wherein said expansion ratio is a ratio of a sum of two positive integers m and n to said m so that said source signal is configured to be expanded by a percentage corresponding to a product of said n and 100 divided by said m, said system comprising:
a separation unit which is configured to obtain said source signal and to separate said source signal into a first plurality of sub-signals based upon a plurality of different ranges of frequency such that each of said sub-signals is configured to include some of said pulses having frequencies in one of said ranges;
a division unit which is configured to divide each of said sub-signals into a different number of segments, wherein each of at least a substantial number of said segments are configured to include said m pulses and wherein at least a substantial number of said segments are configured to start and terminate at an at least substantially similar amplitude for each of said sub-signals;
an expansion unit which is configured to provide said different number of expanded segments for each of said sub-signals and to then provide said first plurality of expanded sub-signals, wherein each of at least a substantial number of said expanded segments is configured to include one of said segments including said m pulses and said n pulses of said one of said segments appended thereto, wherein at least a substantial number of said appended pulses for said segments are also configured to start and to end at said amplitude, and wherein each of said expanded sub-signals is configured to include all of said expanded segments thereof, thereby at least substantially preventing formation of discontinuities in said amplitudes between said segments and appended pulses; and
an output unit which is configured to superpose said expanded sub-signals one over the other and to generate said expanded signal therefrom.

10. The system of claim 9, wherein said separation unit is configured to allocate each of at least a substantial number of said pulses to only one of said sub-signals depending upon frequency of said each of at least a substantial number of said pulses.

11. The system of claim 9, wherein said separation unit is configured to allocate each of at least one of said pulses to more than one of said sub-signals depending upon frequency of said each of at least one of said pulses.

12. The system of claim 9, wherein said separation unit is configured to separate into a first sub-signal including said pulses in a first range of frequency and a first last sub-signal having a first rest of said pulses of said source signal, to assess whether said first rest of said pulses satisfy a preset criterion, and to separate said first last sub-signal into a next sub-signal including said pulses in a next range of frequency and a next last sub-signal including the next rest of of said pulses of said first last sub-signal until said next rest of said pulses satisfy said preset criterion.

13. The signal processing system of claim 9, wherein said amplitude is at least substantially close to zero.

14. The signal processing system of claim 9, wherein said amplitude is at least substantially close to a preset nonzero constant.

15. The signal processing system of claim 9, wherein said division unit is configured to divide said sub-signals into said segments at least a substantial number of which are configured to start and end at said amplitude.

16. The signal processing system of claim 9, wherein each of at least a substantial number of said segments is configured to have an at least substantially similar number of said pulses in each of said sub-signals.

17. The signal processing system of claim 9, wherein at least one of said sub-signals covering a higher-frequency range is configured to include more of said segments than at least one of said sub-signals covering a lower frequency range.

18. The signal processing system of claim 9, wherein at least one of said expanded segments for one of said segments is configured to include at least one of said pulses of another of said segments neighboring said one of said segments.

19. The signal processing system of claim 9, wherein at least one of said expanded segments for one of said segments is configured to be at least one of averaged, filtered, smoothened, interpolated, and spline-fitted.

20. A method of temporally expanding a source signal by a preset expansion ratio without at least substantially distorting its frequency distribution, wherein said source signal is a pulse train including a plurality of pulses therealong, said method comprising the steps of:
separating said source signal into a first sub-signal having some of said pulses in a first range of frequency and a first last sub-signal having the first rest of said pulses of said source signal;
assessing whether said first rest of said pulses meet a preset criterion;
dividing said first last sub-signal into a next sub-signal including some of said pulses in a next range of frequency and a next last sub-signal including the next rest of of said pulses of said first last sub-signal until;
repeating said assessing and dividing until said next rest of said pulses meet said criterion;
providing a different number of appended portions for each of said sub-signals based on said expansion ratio;
identifying a plurality of locations along each of said sub-signals;
appending each of said portions onto each of said locations of each of said sub-signals, while arranging a length of each of said portions for said first sub-signal to be longer (or shorter) than a last length of each of said portions for said last sub-signal, providing a first total number of said portions for said first sub-signals to be less (or greater) than a last total number of said portions for said last sub-signal, and arranging a product of said first length and number to be at least substantially similar to a product of said last length and number; and
adding (or superposing) said sub-signals appended by said portions, thereby expanding said source signal into said expanded signal by said expansion ratio while at least substantially preserving said frequency distribution of said source signal in said expanded signal.
